(19) United States
(12) Patent Application Publication
(10) Pub. No.: US 2024/0232623 A1
(43) Pub. Date: Jul. 11, 2024

(54) ACOUSTIC SIGNAL CONNECTION SYSTEM

(71) Applicant: Schlumberger Technology Corporation, Sugar Land, TX (US)

(72) Inventors: Pontus Loviken, Clamart (FR); James Matthews, Houston, TX (US); Onur Ozen, Clamart (FR); Yong Wee Lee, Singapore (SG); Haw Keat Lim, Singapore (SG); Josselin Kherroubi, Clamart (FR)

(21) Appl. No.: 18/558,952

(22) PCT Filed: Apr. 28, 2022
(86) PCT No.: PCT/US2022/026774

§ 371 Date: Nov. 3, 2023

Related U.S. Application Data
(60) Provisional application No. 63/185,135, filed on May 6, 2021.

(51) Int. Cl. G06N 3/08; E21B 47/095; G01S 15/08

(52) U.S. Cl. CPC G06N 3/08; E21B 47/095; G01S 15/08; E21B 2200/22

(57) ABSTRACT

A method can include acquiring acoustic signals responsive to emissions into equipment: and generating an output signal by inputting the acoustic signal into a machine learning model, where the output signal is indicative of a positional arrangement of two pieces of the equipment.

### RELATED APPLICATIONS

This application claims priority to and the benefit of a US Provisional application having Ser. No. 63/185,135, filed May 6, 2021, which is incorporated by reference herein.

### BACKGROUND

Various types of system components can be utilized in fluid transport, fluid control, fluid operations, etc. For example, a pipe can be utilized for fluid transport, a valve can be utilized for fluid control, and a pump can be utilized for fluid operations. As an example, a reservoir can be a subterranean reservoir that includes fluid where various types of fluid system components may be utilized at the surface or below the surface (e.g., subsurface or subterranean). Where a borehole is drilled into a subterranean environment, which may include a reservoir, various types of system components may be utilized at the surface of the borehole, if the borehole extends to the surface, and various types of system components may be utilized downhole, for example, positioned in the borehole a depth or depths from the surface using one or more types of operations (e.g., rig, wireline, pump-down, etc.). In various environment (e.g., offshore, near shore, reservoir, etc.), one or more system components may be exposed to fluid at an interior surface, which may be at a junction between two or more system components.

### SUMMARY

A method can include acquiring acoustic signals responsive to emissions into equipment; and generating an output signal by inputting the acoustic signal into a machine learning model, where the output signal is indicative of a positional arrangement of two pieces of the equipment. A system can include a processor; memory accessible to the processor; processor executable instructions stored in the memory, executable by the processor to instruct the system to: acquire acoustic signals responsive to emissions into equipment; and generate an output signal by inputting the acoustic signal into a machine learning model, where the output signal is indicative of a positional arrangement of two pieces of the equipment. One or more computer-readable storage media can include processor executable instructions, executable to instruct a computing system to: acquire acoustic signals responsive to emissions into equipment; and generate an output signal by inputting the acoustic signal into a machine learning model, where the output signal is indicative of a positional arrangement of two pieces of the equipment.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of an environment with equipment and examples of equipment;

FIG. 2 illustrates an example of a wellsite system and examples of various boreholes;

FIG. 3 illustrates an example of a system and an example of an assembly;

FIG. 4 illustrates an example of an assembly;

FIG. 5 illustrates an example of an assembly;

FIG. 6 illustrates an example of a system;

FIG. 7A and FIG. 7B illustrates examples of equipment assembly states;

FIG. 8 illustrates an example of a portion of an assembly;

FIG. 9 illustrates an example of a plot;

FIG. 10 illustrates examples of plots;

FIG. 11 illustrates examples of plots;

FIG. 12 illustrates an example of a plot;

FIG. 13 illustrates examples of plots;

FIG. 14 illustrates an example of signal acquisition;

FIG. 15 illustrates examples of plots;

FIG. 16 illustrates example characteristics of a machine learning model;

FIG. 17 illustrates an example of a plot;

FIG. 18 illustrates examples of plots;

FIG. 19 illustrates examples of plots;

FIG. 20 illustrates examples of plots;

FIG. 21 illustrates examples of plots;

FIG. 22 illustrates examples of plots;

FIG. 23 illustrates examples of plots;

FIG. 24 illustrates an example of a method;

FIG. 25 illustrates an example of a computing system and an example of a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

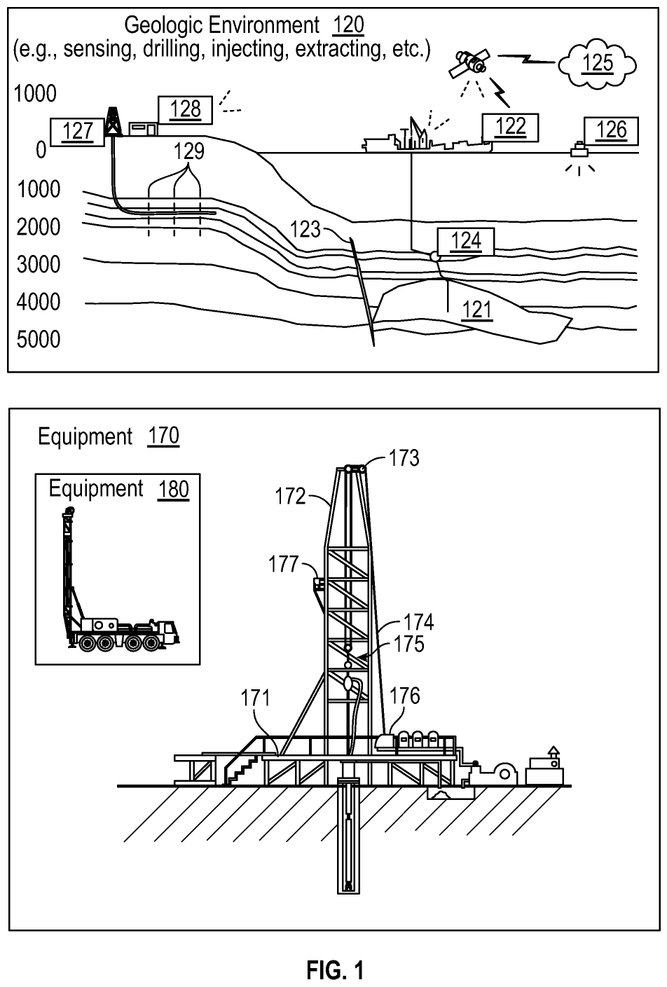

FIG. 1 shows an example of a geologic environment 120. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with any of a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more pieces of equipment may provide for measurement, collection, communication, storage, analysis, etc. of data (e.g., for one or more produced resources, etc.). As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, injection, production, etc. As an example, the equipment 127 and/or 128 may provide for measurement, collection, communication, storage, analysis, etc. of data such as, for example, production data (e.g., for one or more produced resources). As an example, one or more satellites may be provided for purposes of communications, data acquisition, etc.

FIG. 1 also shows an example of equipment 170 and an example of equipment 180. Such equipment, which may be systems of components, may be suitable for use in the geologic environment 120. While the equipment 170 and 180 are illustrated as land-based, various components may be suitable for use in an offshore system.

The equipment 170 includes a platform 171, a derrick 172, a crown block 173, a line 174, a traveling block assembly 175, drawworks 176 and a landing 177 (e.g., a monkeyboard). As an example, the line 174 may be controlled at least in part via the drawworks 176 such that the traveling block assembly 175 travels in a vertical direction with respect to the platform 171. For example, by drawing the line 174 in, the drawworks 176 may cause the line 174 to run through the crown block 173 and lift the traveling block assembly 175 skyward away from the platform 171; whereas, by allowing the line 174 out, the drawworks 176 may cause the line 174 to run through the crown block 173 and lower the traveling block assembly 175 toward the platform 171. Where the traveling block assembly 175 carries pipe (e.g., casing, etc.), tracking of movement of the traveling block 175 may provide an indication as to how much pipe has been deployed.

A derrick can be a structure used to support a crown block and a traveling block operatively coupled to the crown block at least in part via line. A derrick may be pyramidal in shape and offer a suitable strength-to-weight ratio. A derrick may be movable as a unit or in a piece-by-piece manner (e.g., to be assembled and disassembled).

As an example, drawworks may include a spool, brakes, a power source and assorted auxiliary devices. Drawworks may controllably reel out and reel in line. Line may be reeled over a crown block and coupled to a traveling block to gain mechanical advantage in a “block and tackle” or “pulley” fashion. Reeling out and in of line can cause a traveling block (e.g., and whatever may be hanging underneath it), to be lowered into or raised out of a bore. Reeling out of line may be powered by gravity and reeling in by a motor, an engine, etc. (e.g., an electric motor, a diesel engine, etc.).

As an example, a crown block can include a set of pulleys (e.g., sheaves) that can be located at or near a top of a derrick or a mast, over which line is threaded. A traveling block can include a set of sheaves that can be moved up and down in a derrick or a mast via line threaded in the set of sheaves of the traveling block and in the set of sheaves of a crown block. A crown block, a traveling block and a line can form a pulley system of a derrick or a mast, which may enable handling of heavy loads (e.g., drillstring, pipe, casing, liners, etc.) to be lifted out of or lowered into a bore. As an example, line may be about a centimeter to about five centimeters in diameter as, for example, steel cable. Through use of a set of sheaves, such line may carry loads heavier than the line could support as a single strand.

As an example, a derrickman may be a rig crew member that works on a platform attached to a derrick or a mast. A derrick can include a landing on which a derrickman may stand. As an example, such a landing may be about 10 meters or more above a rig floor. In an operation referred to as trip out of the hole (TOH), a derrickman may wear a safety harness that enables leaning out from the work landing (e.g., monkeyboard) to reach pipe in located at or near the center of a derrick or a mast and to throw a line around the pipe and pull it back into its storage location (e.g., fingerboards), for example, until a time at which it may be desirable to run the pipe back into the bore. As an example, a rig may include automated pipe-handling equipment such that the derrickman controls the machinery rather than physically handling the pipe.

As an example, a trip may refer to the act of pulling equipment from a bore and/or placing equipment in a bore. As an example, equipment may include a drillstring that can be pulled out of a hole and/or placed or replaced in a hole. As an example, a pipe trip may be performed where a drill bit has dulled or has otherwise ceased to drill efficiently and is to be replaced.

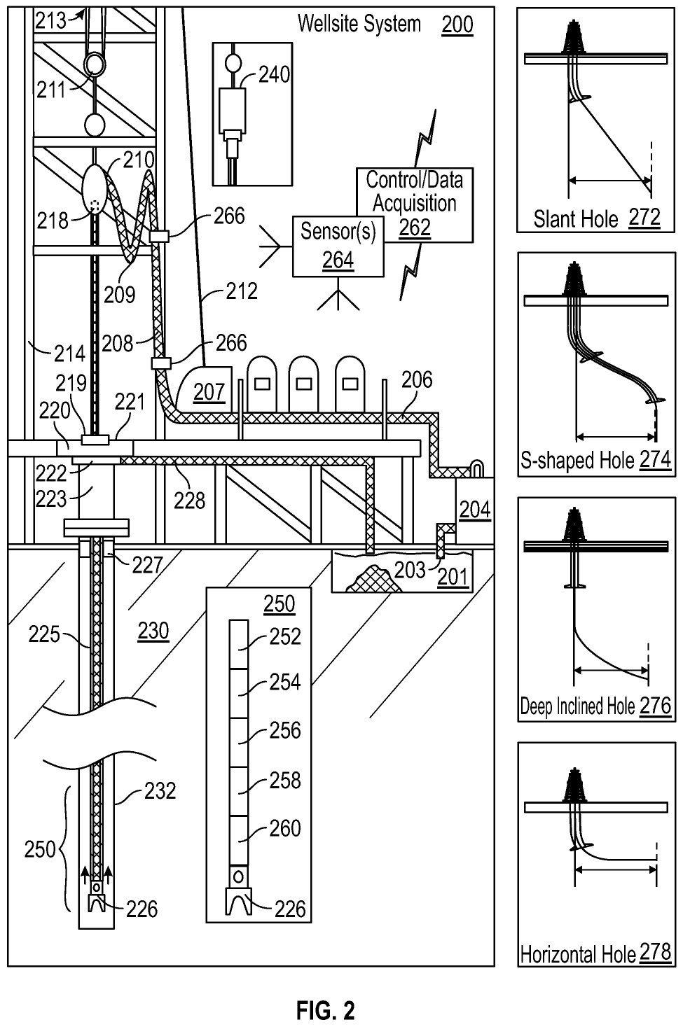

FIG. 2 shows an example of a wellsite system 200 (e.g., at a wellsite that may be onshore or offshore). As shown, the wellsite system 200 can include a mud tank 201 for holding mud and other material (e.g., where mud can be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212 (see, e.g., the crown block 173 of FIG. 1), a derrick 214 (see, e.g., the derrick 172 of FIG. 1), a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use directional drilling.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 can provide for operation of the drillstring 225 and other operations. As shown, the wellsite system 200 includes the platform 211 and the derrick 214 positioned over the borehole 232. As mentioned, the wellsite system 200 can include the rotary table 220 where the drillstring 225 pass through an opening in the rotary table 220.

As shown in the example of FIG. 2, the wellsite system 200 can include the kelly 218 and associated components, etc., or a top drive 240 and associated components. As to a kelly example, the kelly 218 may be a square or hexagonal metal/alloy bar with a hole drilled therein that serves as a mud flow path. The kelly 218 can be used to transmit rotary motion from the rotary table 220 via the kelly drive bushing 219 to the drillstring 225, while allowing the drillstring 225 to be lowered or raised during rotation. The kelly 218 can pass through the kelly drive bushing 219, which can be driven by the rotary table 220. As an example, the rotary table 220 can include a master bushing that operatively couples to the kelly drive bushing 219 such that rotation of the rotary table 220 can turn the kelly drive bushing 219 and hence the kelly 218. The kelly drive bushing 219 can include an inside profile matching an outside profile (e.g., square, hexagonal, etc.) of the kelly 218; however, with slightly larger dimensions so that the kelly 218 can freely move up and down inside the kelly drive bushing 219.

As to a top drive example, the top drive 240 can provide functions performed by a kelly and a rotary table. The top drive 240 can turn the drillstring 225. As an example, the top drive 240 can include one or more motors (e.g., electric and/or hydraulic) connected with appropriate gearing to a short section of pipe called a quill, that in turn may be screwed into a saver sub or the drillstring 225 itself. The top drive 240 can be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 can hold mud, which can be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via the lines 206, 208 and 209 to a port of the kelly 218 or, for example, to a port of the top drive 240. The mud can then flow via a passage (e.g., or passages) in the drillstring 225 and out of ports located on the drill bit 226 (see, e.g., a directional arrow). As the mud exits the drillstring 225 via ports in the drill bit 226, it can then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional, or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drill string 225 may be pulled from a wellbore and optionally replaced, for example, with a new or sharpened drill bit, a smaller diameter drill string, etc. As mentioned, the act of pulling a drill string out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drill string 225 at a bottom of a wellbore, pumping of the mud commences to lubricate the drill bit 226 for purposes of drilling to enlarge the wellbore. As mentioned, the mud can be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may be modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such an example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measuring-while-drilling (MWD) module 256, an optional module 258, a roto-steerable system and motor 260, and the drill bit 226. Such components or modules may be referred to as tools where a drillstring can include a plurality of tools.

The LWD module 254 may be housed in a suitable type of drill collar and can contain one or a plurality of selected types of logging tools. It will also be understood that more than one LWD and/or MWD module can be employed, for example, as represented by the module 256 of the drillstring assembly 250. Where the position of an LWD module is mentioned, as an example, it may refer to a module at the position of the LWD module 254, the module 256, etc. An LWD module can include capabilities for measuring, processing, and storing information, as well as for communicating with the surface equipment. In the illustrated example, the LWD module 254 may include a seismic measuring device.

The MWD module 256 may be housed in a suitable type of drill collar and can contain one or more devices for measuring characteristics of the drillstring 225 and the drill bit 226. As an example, the MWD tool 254 may include equipment for generating electrical power, for example, to power various components of the drillstring 225. As an example, the MWD tool 254 may include the telemetry equipment 252, for example, where the turbine impeller can generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform a method such as geosteering. As an example, a steerable system can include a PDM or a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density, and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 can include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 can be provided for tracking pipe, tracking movement of at least a portion of a drillstring, etc.

As an example, the system 200 can include one or more sensors 266 that can sense and/or transmit signals to a fluid conduit such as a drilling fluid conduit (e.g., a drilling mud conduit). For example, in the system 200, the one or more sensors 266 can be operatively coupled to portions of the standpipe 208 through which mud flows. As an example, a downhole tool can generate pulses that can travel through the mud and be sensed by one or more of the one or more sensors 266. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 can include a transmitter that can generate signals that can be transmitted downhole via mud (e.g., drilling fluid) as a transmission medium.

As an example, one or more portions of a drillstring may become stuck. The term stuck can refer to one or more of varying degrees of inability to move or remove a drillstring from a bore. As an example, in a stuck condition, it might be possible to rotate pipe or lower it back into a bore or, for example, in a stuck condition, there may be an inability to move the drillstring axially in the bore, though some amount of rotation may be possible. As an example, in a stuck condition, there may be an inability to move at least a portion of the drillstring axially and rotationally.

As to the term “stuck pipe”, this can refer to a portion of a drillstring that cannot be rotated or moved axially. As an example, a condition referred to as “differential sticking” can be a condition whereby the drillstring cannot be moved (e.g., rotated or reciprocated) along the axis of the bore. Differential sticking may occur when high-contact forces caused by low reservoir pressures, high wellbore pressures, or both, are exerted over a sufficiently large area of the drillstring. Differential sticking can have time and financial cost.

As an example, a sticking force can be a product of the differential pressure between the wellbore and the reservoir and the area that the differential pressure is acting upon. This means that a relatively low differential pressure (delta p) applied over a large working area can be just as effective in sticking pipe as can a high differential pressure applied over a small area.

As an example, a condition referred to as “mechanical sticking” can be a condition where limiting or prevention of motion of the drillstring by a mechanism other than differential pressure sticking occurs. Mechanical sticking can be caused, for example, by one or more of junk in the hole, wellbore geometry anomalies, cement, keyseats or a buildup of cuttings in the annulus.

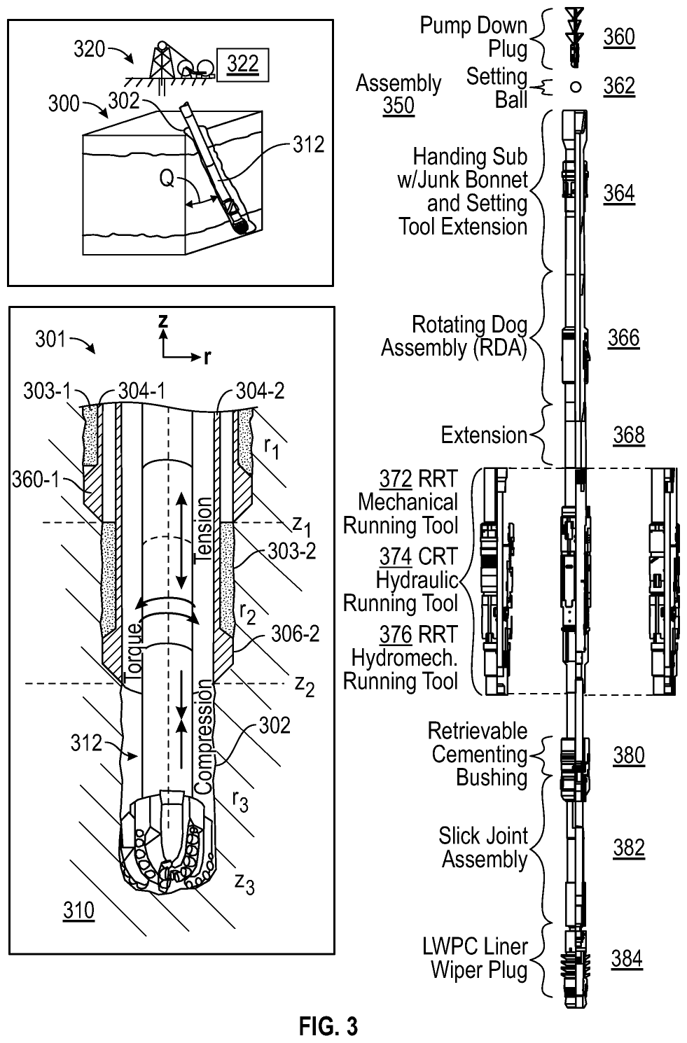

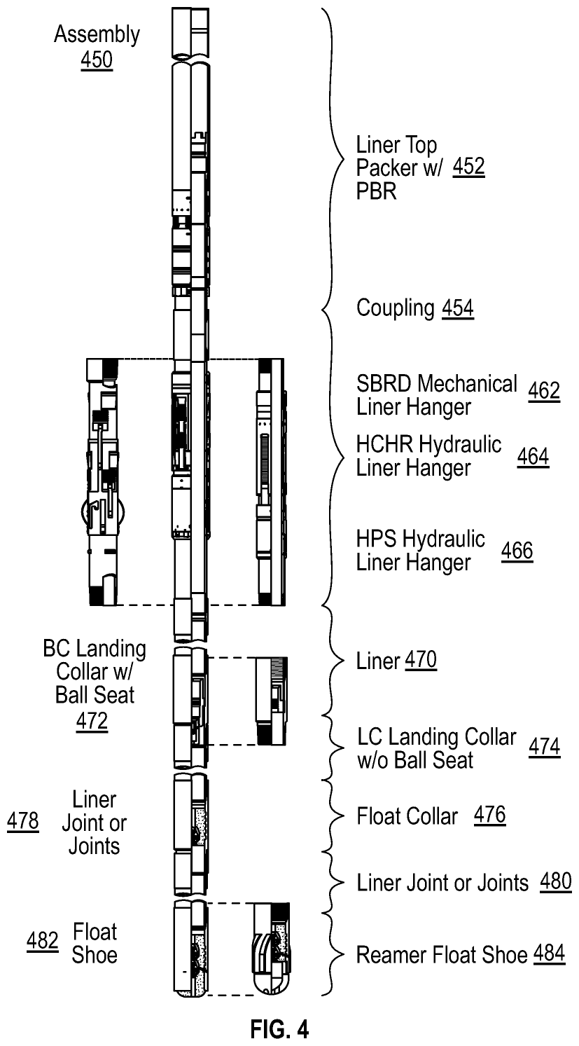

FIGS. 3 and 4 show an example of an environment 300, an example of a portion of a completion 301, an example of equipment 320 and examples of assemblies 350 and 450, which may be utilized in one or more completions operations. As an example, the equipment 320 may include a rig, a turntable, a pump, drilling equipment, pumping equipment, equipment for deploying an assembly, a part of an assembly, etc. As an example, the equipment 320 may include one or more controllers 322. As an example, a controller may include one or more processors, memory and instructions stored in memory that are executable by a processor, for example, to control one or more pieces of equipment (e.g., motors, pumps, sensors, etc.). As an example, the equipment 320 may be deployed at least in part at a well site and, optionally, in part at a remote site.

In FIG. 3, the environment 300 includes a subterranean formation into which a bore 302 extends where a tool 312 such as, for example, a drill string is disposed in the bore 302. As an example, the bore 302 may be defined in part by an angle (Q); noting that while the bore 302 is shown as being deviated, it may be vertical (e.g., or include one or more vertical sections along with one or more deviated sections). As shown in an enlarged view with respect to an r, z coordinate system (e.g., a cylindrical coordinate system), a portion of the bore 302 includes casings 304-1 and 304-2 having casing shoes 306-1 and 306-2. As shown, cement annuli 303-1 and 303-2 are disposed between the bore 302 and the casings 304-1 and 304-2. Cement such as the cement annuli 303-1 and 303-2 can support and protect casings such as the casings 304-1 and 304-2 and when cement is disposed throughout various portions of a wellbore such as the wellbore 302, cement may help achieve zonal isolation.

In the example of FIG. 3, the bore 302 has been drilled in sections or segments beginning with a large diameter section (see, e.g., r₁) followed by an intermediate diameter section (see, e.g., r₂) and a smaller diameter section (see, e.g., r₃). As an example, a large diameter section may be a surface casing section, which may be three or more feet in diameter and extend down several hundred feet to several thousand feet. A surface casing section may aim to prevent washout of loose unconsolidated formations. As to an intermediate casing section, it may aim to isolate and protect high pressure zones, guard against lost circulation zones, etc. As an example, intermediate casing may be set at about 6000 feet (e.g., about 2000 m) and extend lower with one or more intermediate casing portions of decreasing diameter (e.g., in a range from about thirteen to about five inches in diameter). A so-called production casing section may extend below an intermediate casing section and, upon completion, be the longest running section within a wellbore (e.g., a production casing section may be thousands of feet in length). As an example, production casing may be located in a target zone where the casing is perforated for flow of fluid into a bore of the casing.

A liner may be a casing (e.g., a completion component) that may be installed via a liner hanger system. As an example, a liner hanger system may include various features such as, for example, one or more of the features of the assembly 350 and/or the assembly 450 of FIGS. 3 and 4.

As shown in FIG. 3, the assembly 350 can include a pump down plug 360, a setting ball 362, a handling sub with a junk bonnet and setting tool extension 364, a rotating dog assembly (RDA) 366, an extension(s) 368, a mechanical running tool 372, a hydraulic running tool 374, a hydromechanical running tool 376, a retrievable cementing bushing 380, a slick joint assembly 382 and/or a liner wiper plug 384.

As shown in FIG. 4, the assembly 450 can include a liner top packer with a polished bore receptacle (PBR) 452, a coupling(s) 454, a mechanical liner hanger 462, a hydraulic liner hanger 464, a hydraulic liner hanger 466, a liner(s) 470, a landing collar with a ball seat 472, a landing collar without a ball seat 474, a float collar 476, a liner joint or joints 478 and/or 480, a float shoe 482 and/or a reamer float shoe 484.

One or more pieces of equipment of FIG. 3 or FIG. 4 can include one or more sensors, that may be part of a circuit or circuits that can generate one or more signals. As an example, a signal may be an inherent signal or a signal that is altered (e.g., responsive to force, degradation, contact, proximity, etc.).

As shown in FIG. 3, the tool 312 may experience one or more of tension, torque (e.g., torsion) and compression. Where the tool 312 includes one or more sensors, the tool 312 may be a smart tool that can generate a signal or signals responsive to one or more of tension, torsion and compression.

As an example, one or more of the casings 304-1 and 304-2 and/or one or more of the casing shoes 306-1 and 306-2 can include one or more sensors.

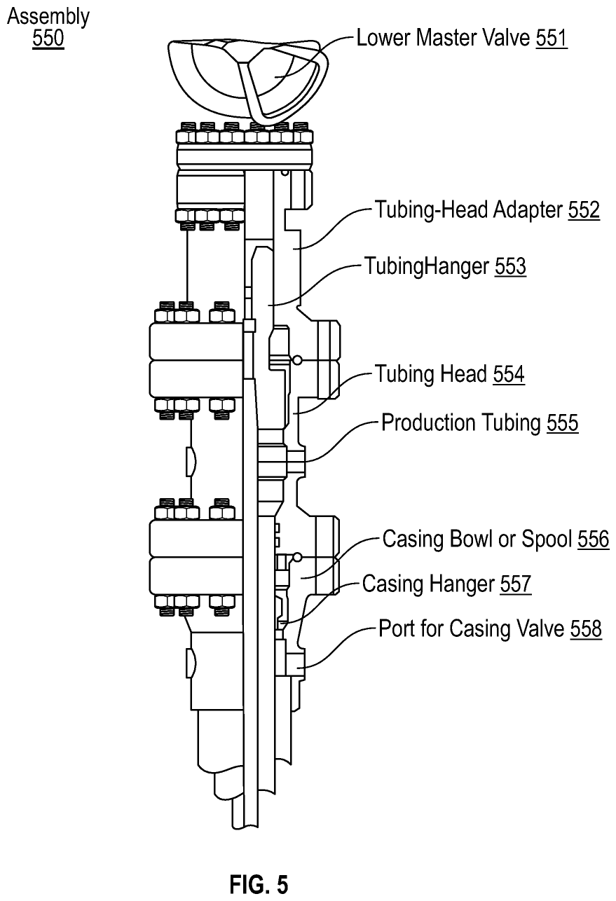

FIG. 5 shows an example of an assembly 550 that may be referred to as a wellhead assembly of wellhead equipment. As shown, the assembly 550 includes a lower master valve 551, a tubing-head adapter 552, a tubing hanger 553, a tubing head 554, a production tubing 555, a casing bowl or spool 556, a casing hanger 557 and a port for a casing valve 558.

In completions, a wellhead assembly can be a surface termination of a wellbore that incorporates facilities for installing casing hangers during well construction. A wellhead assembly can also include features for hanging production tubing and installing a Christmas tree and surface flow-control facilities, for example, in preparation for production of fluid from a well.

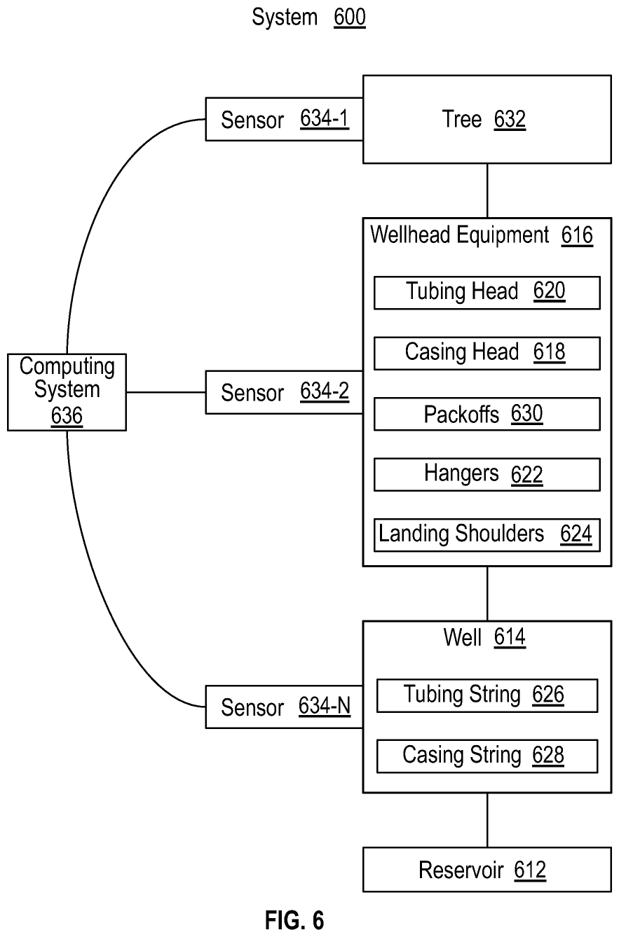

FIG. 6 shows an example of a system 600 that includes a wellhead assembly that facilitates extraction of a resource, such as oil, from a reservoir 612 through a well 614. The wellhead assembly includes wellhead equipment 616 installed on the well 614. As depicted, the wellhead equipment 616 includes at least one casing head 618 and tubing head 620, as well as wellhead hangers 622 and landing shoulders 624. Components of the wellhead equipment 616 can differ between applications, and could include a variety of components such as, for example, casing heads, tubing heads, spools, hangers, sealing assemblies (e.g., packoffs 630), stuffing boxes, pumping tees, pressure gauges, etc.

The wellhead hangers 622 can be positioned on landing shoulders 624 within hollow pressure-containing housings of the wellhead (e.g., within the tubing and casing heads 620 and 618). The landing shoulders 624 can be integral parts of tubing and casing heads 620 and 618 or can be provided by other components, such as sealing assemblies, landing rings, or other hangers 622 disposed in the tubing and casing heads. Each of the hangers 622 can be connected to a tubular string, such as a tubing string 626 or a casing string 628, to suspend the string within the well 614. The well 614 can include a single casing string 628 or include multiple casing strings 628 of different diameters, which may be cemented in place within the well 614. In some embodiments, the wellhead assembly includes a tree 632 (e.g., a production tree) coupled to the wellhead equipment 616. In other instances, wellhead assemblies could also or instead include other components coupled to the wellhead equipment 616, such as, for example, blowout preventers, drilling adapters, connecters, etc.

A bore through the wellhead assembly allows objects, such as a drill string or various tools, to pass into the well 614. Various internal wellhead objects, such as the hangers 622, the packoffs 630, or locking assemblies, can be lowered into the bore and landed within a pressure-containing housing of the wellhead assembly.

The wellhead assembly in the example of FIG. 6 includes sensors 634-1, 634-2, . . . , 634-N for sensing the position of objects, which can include one or more internal wellhead objects within the bore of the wellhead assembly. The sensors 634-1, 634-2, . . . , 634-N are shown coupled to the well 614, the wellhead equipment 616 and/or the tree 634; noting that one or more sensors may also or instead be positioned elsewhere (e.g., on drilling adapters, blowout preventers, etc.).

A sensor may be an acoustic type of sensor and/or another type of sensor. For example, consider one or more of ultrasonic sensors, acoustic sensors, proximity sensors, magnetic sensors, or optical sensors (e.g., or combinations of multiple sensor types).

As shown, a computing system 636 can be operatively coupled via wire and/or wirelessly to one or more of the sensors 634-1, 634-2, . . . , 634-N. The computing system 636 may receive and process data and/or other signals, for example, to determine position or positions of equipment such as, for example, the position of an internal wellhead object within the bore.

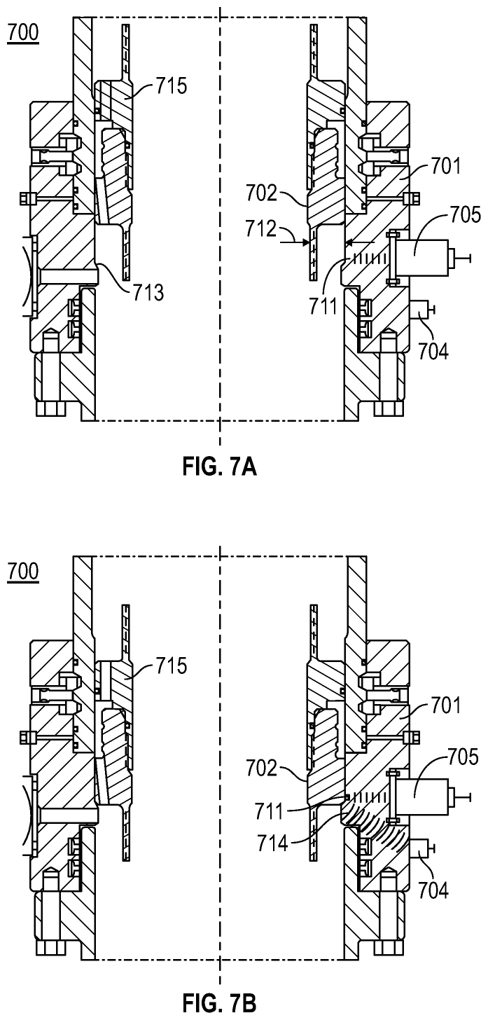

FIGS. 7A and 7B show an assembly 700 as part of a process that involves landing. As shown the assembly 700 can be utilized to identify the landing position of a hanger 702 at a target location within a wellhead. More specifically, a hanger landing operation can involve lowering the hanger 702 within a bore of a housing 701 of the assembly 700 to land the hanger 702 on a landing shoulder 713. The hanger 702 can be lowered into the bore with a running tool 715. As shown, one or more acoustic sensors 704 are able to detect the acoustic signature of the hanger 702 (e.g., to detect the sound made by landing the hanger 702 on landing shoulder 713, as represented by sound waves 714) to indicate that the hanger 702 is in the process of landing. Additionally, an ultrasonic sensor 705 can take measurements to indicate that the hanger 702 has properly landed within the housing 701 at the target position.

The ultrasonic sensor 705 may be positioned to emit ultrasonic waves (shown here generally as a beam 711 of ultrasonic waves) into the bore of the wellhead assembly 700 and can be used to detect landing of the hanger 702 on the landing shoulder 713. The ultrasonic sensor may emit wave pulses or continuous waves. In one embodiment, the ultrasonic sensor 705 emits ultrasonic waves that are at least partially reflected from objects (e.g., the hanger 702) in their path. In some embodiments, the ultrasonic sensor 705 is operated in a reflection mode (e.g., a pulse-echo mode) and both emits the ultrasonic waves into the bore and receives reflections of those waves from various material boundaries encountered by the waves, such as the outer surface of the housing 701, the inner surface of the housing 701, and the outer surface of the hanger 702. It will be appreciated that the ultrasonic sensor 705 can be used to sense an ultrasonic signature of an observed region based on the time-of-flight, intensity, or other characteristics of the reflected ultrasonic waves received by the ultrasonic sensor 705, and that these characteristics will depend on distances traveled and materials encountered by the ultrasonic waves.

In some embodiments, the ultrasonic sensor 705 can be used to measure a distance between the ultrasonic sensor 705 and the hanger 702 (e.g., the total distance between the ultrasonic sensor 705 and the hanger 702 or a distance across gap 712 between the hanger 702 and the bore wall of the housing 701) based on the emission, reflection, and sensing of the ultrasonic waves. When the hanger 702 is positioned as shown in FIG. 7A, the gap 712 between the outer surface of the lower end of the hanger 702 is sensed using the ultrasonic sensor 705 and indicates that the hanger 702 has not landed on the shoulder 713. As depicted in FIG. 7B, however, once landed on the shoulder 713, a wider portion of the hanger 702 is positioned in front of the ultrasonic beam 711 and reflects ultrasonic waves back to the ultrasonic sensor 705.

The ultrasonic waves reflected from the outer surface of the hanger 702 in FIG. 7B arrive at the sensor 705 faster than the ultrasonic waves that were reflected from the lower, narrower end of the hanger 702 toward which the beam 711 is emitted in FIG. 7A.

This difference may be sensed and used to identify the location of the hanger 702 within the bore. One or more ultrasonic sensors 705 may also or instead be used to identify the location of some other object within the bore, such as a packoff or a running tool.

As shown in FIGS. 7A and 7B, the ultrasonic sensor 705 is positioned at an axial location along the housing 701 to emit the beam 711 of ultrasonic waves toward the landing shoulder 713 in a plane perpendicular to the axis of the housing 701 (e.g., with the beam 711 emitted radially inward into the bore). In this arrangement, the presence of the hanger 702 on the shoulder 713 causes a detectable difference in the ultrasonic signature sensed by the ultrasonic sensor 705 (e.g., in the timing of the receipt of ultrasonic waves received by the sensor 705) and allows detection of the landing of the hanger 702 on the shoulder 713. But the one or more ultrasonic sensors 705 can be positioned elsewhere in other embodiments. Additionally, while the ultrasonic sensor 705 depicted in FIGS. 7A and 7B can be used in a reflection mode to both send ultrasonic waves and receive reflections of those ultrasonic waves, in other instances multiple ultrasonic sensors 705 could be used in a pitch-catch mode in which one sensor 705 emits ultrasonic waves and another sensor 705 receives those ultrasonic waves. As an example, an ultrasonic transducer may be one or more of a single-element, dual-element, annular, linear, or phased-array transducer (e.g., emitting at a suitable ultrasonic frequency or frequencies).

As various types of equipment may be relatively inaccessible to visual inspection by a human, one or more techniques may be employed using machine inspection. As explained, machine inspection can include use of one or more types of sensors that may emit energy and receive energy, which can include one or more of reflected energy and transmitted energy. For example, a single sensor may be an emitter and a receiver whereas a two-part sensor may include an emitter and a receiver that are on the same side of a joint or on different sides of a joint. Where an emitter and a receiver are on different sides of a joint, the receiver may receive transmitted energy and, in various instances, some forms of reflected energy; whereas, when an emitter and a receiver are on the same side, the receiver may receive reflected energy as transmitted energy may be directed away from the receiver (e.g., not within a field-of-view (FOV) of the receiver).

As an example, a workflow can allow for automatic verification of casing hanger alignment within a wellhead, without opening the wellhead (e.g., without visual inspection by a human). Such a workflow can include using recorded signals from one or more transducers placed on the wellhead (e.g., positioned on an exterior surface, etc.). In such an example, the transducers can send a sound pulse into the wellhead and record an echo, which changes slightly depending on the casing hanger alignment.

As an example, a method can include analysis of recordings utilizing high dimensional vectors. For example, consider an approach that utilizes a machine learning model (ML model) to match one high dimensional vector x to another vector θ such that the dot product of the two vectors (e.g., x·θ) becomes larger when a landing of one component with respect to another component is acceptably aligned. In such an approach, where a gap exists, the dot product is less than a maximum, which can infer that the landing is sub-optimal. As explained, a vector-based approach may be utilized to determine landing quality via one or more transducer signals.

Various landing process trials acquired approximately 500 recordings on wellheads filled with fluid (water) and, through a vector-based approach, distinguished acceptable landings and those with unacceptable gaps in more than 99 percent of the trials.

As an example, a method can include receiving raw transducer signals, for example, signals without pre-processing other than averaging over multiple signals from a common context. Such a method may utilize transducers that can record an echo with timing and accuracy that allows for recordings to be highly synchronized.

A machine learning model (ML model) can be utilized in one or more manners to assess data. For example, a ML model may be implemented to assess relationships between data points, to fit each of a plurality of data points to particular value, etc. A so-called Siamese network is a type of ML model that can be utilized to determine similarity between two data points, for example, to determine whether the two data points belong to the same class or not. In such an approach, a method can include passing the data points through a Siamese network to generate a lower dimensional representation of each of the data points. These lower dimensional representations can then be compared to each other, for example, using contrastive loss or triplet loss to determine whether they are similar enough to be considered members of the same class. Such an approach is particularly suited to scenarios where many classes exist (e.g., greater than a few classes) and where there are not many samples of each class, as the network would be forced to find a representation of the data that maps similar objects to similar parts of the representation space, which means that it can often learn to recognize new classes with relatively few samples of each class. Siamese networks have been applied to tasks such as face identification, multi-task learning, drug discovery, protein structure prediction, and image retrieval.

As to sensor data for assessing positional relationships of equipment, rather than determining classes of data points, a ML model can be implemented to determine whether one data point is “better” than another for purposes of ranking. Ranking tasks can exist in search engine retrieval, for example, using a linear support vector machine (SVM) such as RankSVM (e.g., using a mapping function to describe a match between a search query and the features of each of the possible results). As an example, rankings (e.g., using the same network multiple times to compute one element of the loss) can be created by letting the network assign a score to each data point, and then perform a global ranking based on these scores. In such an approach, a global ranking can be along a spectrum as to what score is “better than” another score.

Another approach is referred to as RankNet, which includes a deep neural network (DNN) that can provide for ranking (e.g., webpages, etc.). RankNet can utilize a probabilistic cost for training systems to learn ranking functions using pairs of training examples. The approach can be used for a differentiable function and a neural network formulation (e.g., “RankNet”). The RankNet approach can be trained and utilized for a ranking task. Comparing the linear RankNet with other linear systems demonstrates benefits of using a pair-based cost function together with gradient descent. The RankNet approach can implement a two-layer network. As an example, a deep ranking network approach may be utilized such as, for example, in finding the best frame in video, image quality, image attribute learning, skill determination, essay scoring and medical image analysis. As an example, a RankNet approach may utilize one or more types of networks that can output a score and train on pair loss. As an example, a perceptron (a 2-layered network being a special case, a dot-product as another), a CNN, or a parameterized policy that outputs a score may be utilized.

As an example, the RankNet approach may be utilized for assessing positional relationships of equipment. For example, consider assigning a score to each data point and then minimizing pairwise error. In such an example, the pairwise error refers to the probability that the lower ranked sample out of a given pair in a dataset would be scored higher than the other.

As an example, a method can implement a ML model to create rankings and/or to solve one or more classification problems and/or regression problems via transformation into a ranking problem. In the domain of image aesthetic assessment, a ranking approach may be a “unified” approach for three types of problems (e.g., score regression, binary classification, and personalization) in an aesthetic assessment of images.

As explained, one or more types of ML models may be utilized with one or more types of loss. In various instances, an approach to loss may dictate performance for a particular task or tasks. In various instances, a method can include utilizing the same ML model (e.g., a common neural network) multiple times to compute one element of the loss, for example, where the total loss is a sum or mean of loss elements.

In various instances, a loss can be an accumulation of partial losses. As an example, a method can include selecting a definition for each partial loss and how an accumulation may be computed. For example, consider one partial loss for each data point, which can be a measure of how similar the network output of that data point is to a known ideal output. As another example, each loss element can be based on relationships of pairs of points. As explained, one or more types of ML models may be utilized to transform data points into scores, from which a loss can be computed.

The term Siamese stems from “twin” or “twins”, for example, consider twin neural networks (TNNs). Medically, a Siamese twin is an identical (monozygotic) twin that did not separate fully from another. As an example, a ML model can utilize a score-based loss that provides for determining how similar objects are (e.g., Siamese) or for proper ordering of scores of objects (e.g., ranking). For the latter, a loss can be utilized that effectively checks if objects are properly ordered (e.g., pairwise) and/or a loss can be for whole ranking, or sub-rankings of 3-data points, 4 data-points, etc. For example, consider a method that can utilize one or more losses that may include a loss or losses that look at a subset of data-points and scores as to how well-ranked. As an example, a method can include a sub-ranking of pairs of data-points where one or more subsets (e.g., or whole set) may be assessed.

As an example, a ML model may be a type of artificial neural network model that uses the same weights while working in tandem on two different input vectors to compute comparable output vectors. In various instances, one of the output vectors can be provided (e.g., precomputed, acquired, etc.), which may form a baseline against which the other output vector is compared.

In facial recognition, a TNN model approach may utilize precomputed known images of people for comparison to an image of a person. In such an application, one task can be recognizing a person among a large number of other persons (a facial recognition problem) and another task can be verifying a face (verify whether a photo is of the same person as a person claiming that she is that person). A TNN model may handle either task, though with tailored implementation details. Learning in TNN models may utilize triplet loss or contrastive loss. For learning by triplet loss, a baseline vector (e.g., an anchor image) may be compared against a positive vector (e.g., a truthy image) and a negative vector (e.g., a falsy image). In such an approach, the negative vector forces learning in the network, while the positive vector acts like a regularizer. For learning by contrastive loss there is a weight decay to regularize the weights, or some operation like a normalization.

TNN models may be utilized in object tracking via two tandem inputs and similarity measurement. For example, in object tracking, one input may be a pre-selected exemplar image while the other input is a larger search image, where the TNN model aims to locate the exemplar inside of a search image. By measuring similarity between exemplar and each part of the search image, a map of similarity scores can be given by the TNN model. As an example, a fully convolutional network model may be utilized where the process of computing each sector's similarity score can be replaced with a cross correlation layer.

In the aforementioned trials, training data included approximately 80,000 data points where the 500 recordings were assessed in unique pairs (e.g., rather than individually). As an example, higher precision can be reached by different types of pre-processing of signals x, as well as through post-processing where the results of multiple transducers can be compared.

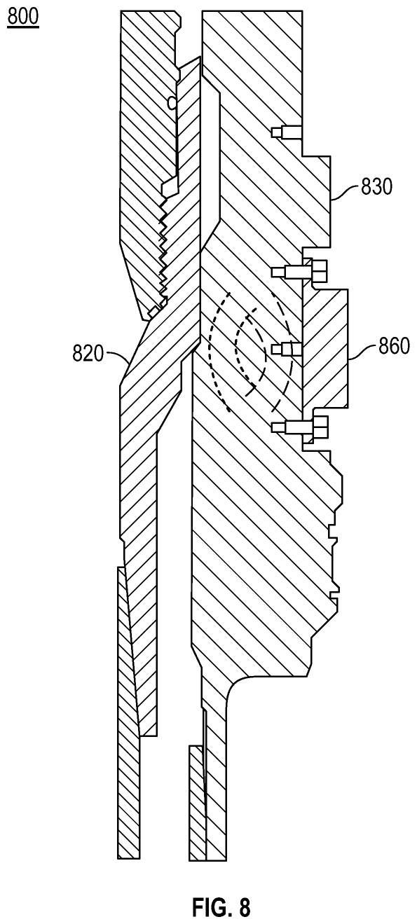

FIG. 8 shows an example of an assembly 800 with an acceptably aligned casing hanger 820 where the casing hanger 820 is landed at the well head landing shoulder 830 without a gap. As shown, a sensor 860 can emit energy and receive energy (e.g., an echo, etc.). In such an example, the sensor 860 may be operatively coupled to one or more pieces of equipment that may provide for control of a landing process. For example, consider a feedback loop where the sensor 860 provides information to a controller such that the controller can acceptably land the casing hanger 820 on the landing shoulder 830.

As an example, a method can automatically detect a gap where the method includes providing acoustic transducers on a wellhead, sequentially, emitting acoustic energy pulses into the wellhead and recording the returning echoes as recorded signals, where each of the recorded signals is N values in length and highly synchronized with respect to the timing of the initial emitted acoustic energy pulse. In such an example, the method can include averaging over the signals of each transducer to generate an average recording for each transducer. In such an approach, each of the average recordings is an N dimensional vector, which may be represented using the following equation:

$$x = {[ {x}_{1} {x}_{2} … {x}_{N} ]}^{T}$$

A method can then provide a vector θ=[θ₁ θ₂ . . . θ_{N}]^{T} (also of length N) such that a score s∈ [symbol] is created using the dot product, for example, as follows:

$$s = x \cdot θ = {\sum }_{i = 1}^{N} {x}_{i} {θ}_{i}$$

In the above equation, if s>s_{T}, where s_{T} is a threshold, then a landing is assumed to be properly aligned (e.g., without an unacceptable gap); whereas, if s<s_{T}, then the result can be interpreted as an incomplete landing (with an unacceptable gap). Where, for example, s≈s_{T}, an inference may be made between multiple transducers to increase accuracy.

The aforementioned method can provide the vector θ using a trained ML model, for example, along with the threshold s_{T}. As such, a ML model may be appropriately trained to output a vector and a scaler for purposes of use in a landing assessment, a landing controller, etc.

As to acquisition of data, consider a laboratory approach where equipment such as a wellhead can be filled with liquid (e.g., water, etc.) or kept dry (e.g., unfilled or filled with air). Single or multiple acoustic transducers can be placed circumferentially around a landing shoulder. Data can be collected during and/or after lowering of a casing hanger with the intent to rest the casing hanger on the landing shoulder. As an example, the transducers can emit acoustic energy pulses and record echoes (e.g., reflected acoustic energy).

As an example, to generate separate channels, each of the transducers can produce a pulse in turn such that pulses from different transducers do not influence each other. Simultaneously a gap, if one exists, is measured in the landing.

As an example, an average recording of a transducer i can be denoted xᵢ, and the corresponding landing status indicated by that transducer can be denoted y, where y=1 if the landing is well aligned with no unacceptable gap, and y=0 if there is an unacceptable gap. For example, given two transducers, each measurement results in two data points (x₁, y), (x₂, y), where xᵢ will be used as input to a ML model, and y will be the label. When later training the ML model, the two data points (x₁, y), (x₂, y) can be kept in the same dataset, so that one data point will not be in the development set or test set when the other is in the training set. Such an approach can help to reduce eventual correlations between data in the different sets that might not exist when evaluating equipment other than the laboratory setup at hand.

As an example, one or more additional pre-processing and/or transformations of x may be performed, which may improve performance. However, as demonstrated, acceptable results can be obtained from a trained ML model (e.g., TNN model, etc.) with averaging and without additional pre-processing and/or transformations. The robust results can be, at least in part, due to a high level of synchronization provided by the transducers. For example, channel separation can reduce noise (e.g., crosstalk, etc.) such that each transducer generates an acceptable vector that can suitably characterize how two components are arranged (e.g., with or without an unacceptable gap).

As to an unacceptable gap, it may be a gap where component to component contact does not exist. In some instances, a gasket may be utilized and/or a clearance (e.g., a small acceptable gap, etc.) may be desired. The aforementioned approach can be utilized in either instance.

As to an approach for finding the vector θ consider a problem cast according to a goal for the vector θ where the goal of the vector θ is to create a score x·θ that is higher when the landing is acceptable (e.g., without an unacceptable gap) and lower when the landing is unacceptable (e.g., with an unacceptable gap). If x_{A} is a recording when the casing hanger is properly aligned with component-to-component contact at particular surfaces (e.g., no gap at the landing shoulder feature) and x_{G} is the recording where there is a gap (e.g., a gap at the landing shoulder feature), then ideally:

$${x}_{A} \cdot θ > {x}_{G} \cdot θ$$

In various instances, an assessment and/or control of a process may proceed without specific knowledge as to the absolute values of the aforementioned scores; rather, their relationship to each other is sufficient to assess and/or control the process.

Given a set of recordings A={x₁^{(A)}, x₂^{(A)}, . . . , x_{M}^{(A)}} where the casing hanger is properly aligned, and a set G={x₁^{(G)}, x₂^{(G)}, . . . , x_{M}^{(G)}} where there is a gap, we define the following loss:

$$L ( θ ) = {\sum }_{{x}_{A} ∈ A} {\sum }_{{x}_{G} ∈ G} {S ( {x}_{G} \cdot θ - {x}_{A} \cdot θ )}^{2}$$

where S(x) is the sigmoid function:

$$S ( x ) = \frac{1}{1 + {e}^{- x}}$$

Above, this loss is equivalent with a Siamese network model (e.g., a TNN model) where the input is a pair (xᵢ, xⱼ) where one is landed and one has a gap, where the prediction is the probability that the first sample is the one corresponding to a full landing.

Considering the aforementioned loss expression L(θ), each term can tend to 0 when x_{A}·θ>>x_{G}·θ, and tend to 1 when x_{A}·θ<<x_{G}·θ. Such a comparison can be made for each member in A to each member in G. In other words, minimizing the loss can help to enforce inequality of the dot products. As the loss is fully differentiable, gradient descent can be utilized.

In a trail, training of the vector θ involved a dataset with 454 samples collected with a wellhead filled with water, where 68 percent of landings included gaps (e.g., unacceptable gaps). The dataset was split into training, development, and test sets. The gradient of the vector ∇θ was taken with respect to the training set. Optimization stopped when the development set was optimized, which was to reduce risk of over fitting. The test set was used to confirm that the development set was not biased.

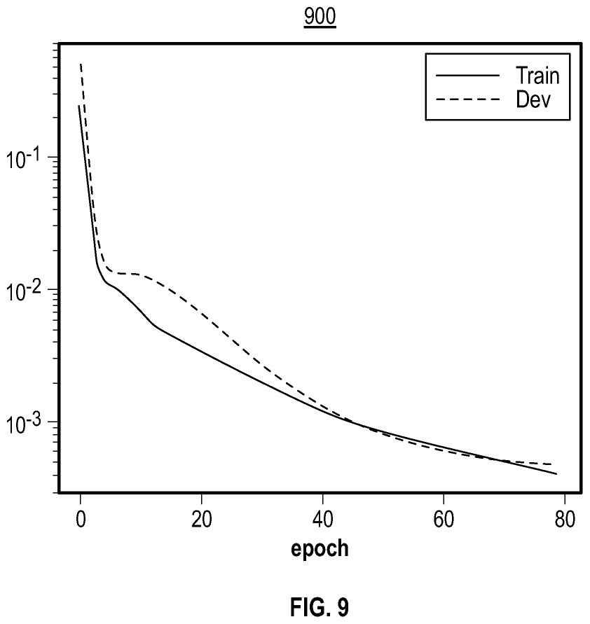

FIG. 9 shows a plot 900 that includes data that demonstrate how the loss changed over time, for each update.

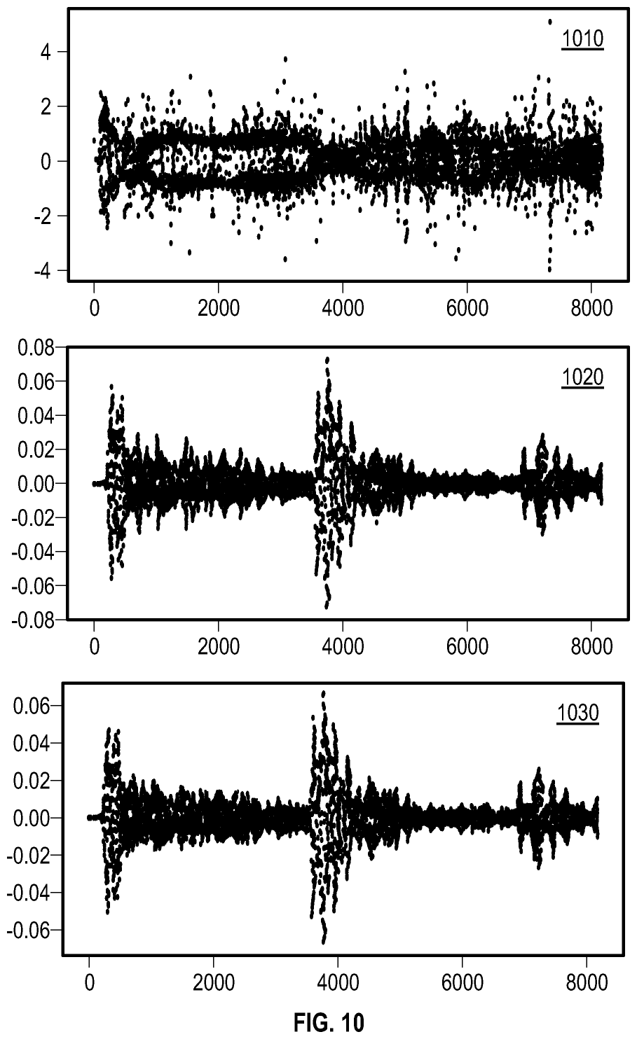

FIG. 10 shows plots of vectors 1010, 1020 and 1030. The plot 1010 shows the final vector θ from the optimization corresponding to the loss plot 900 of FIG. 9. In FIG. 10, the plot 1020 shows an example of a sound vector x_{A} when aligned (no gap) and the plot 1030 shows an example of a sound vector x_{G} with a gap. In FIG. 10, each of the plots 1010, 1020 and 1030 includes over 800 individual points, as may be from a sampling rate of an acoustic energy signal with respect to time (e.g., using an analog to digital converter, etc.). For each time along the horizontal axis, a single value exists.

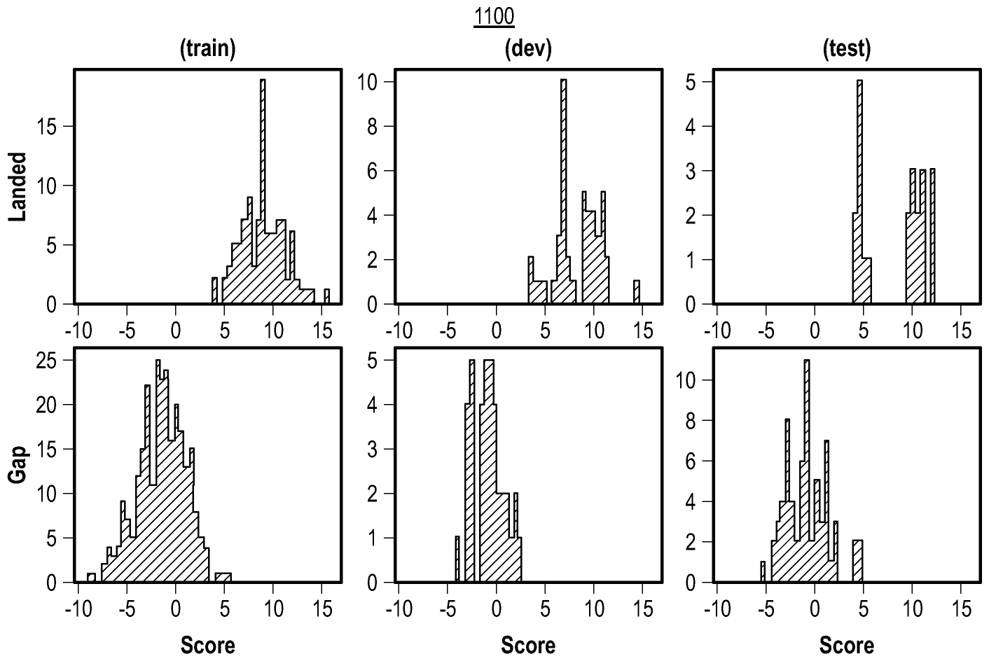

FIG. 11 shows a series of plots 1100 for finding s_{T}. To find an acceptable threshold given the vector θ (see, e.g., the plot 1010), a method can assess the score θ·x given to each sample x in the different sets. Continuing to use the vector θ from the previous example, the histograms of the plots 1100 of FIG. 11 are generated.

In FIG. 11, each of the plots 1100 includes an x-axis that shows the scores θ·x, and columns that show how many samples achieved a corresponding score. In the plots 1100, the upper row shows x∈A and the lower x∈G.

As illustrated in the plots 1100 of FIG. 11, a method can include selecting a threshold s_{T}≠4 where that selected threshold will be able to classify most samples as most landed/aligned scores are above that threshold value and most gap landings are below that threshold value.

As an example, a method may utilize one or more other approaches to determine a threshold value. For example, to find better values for s_{T}, a method may include performing a parameter sweep, which may return an optimal value.

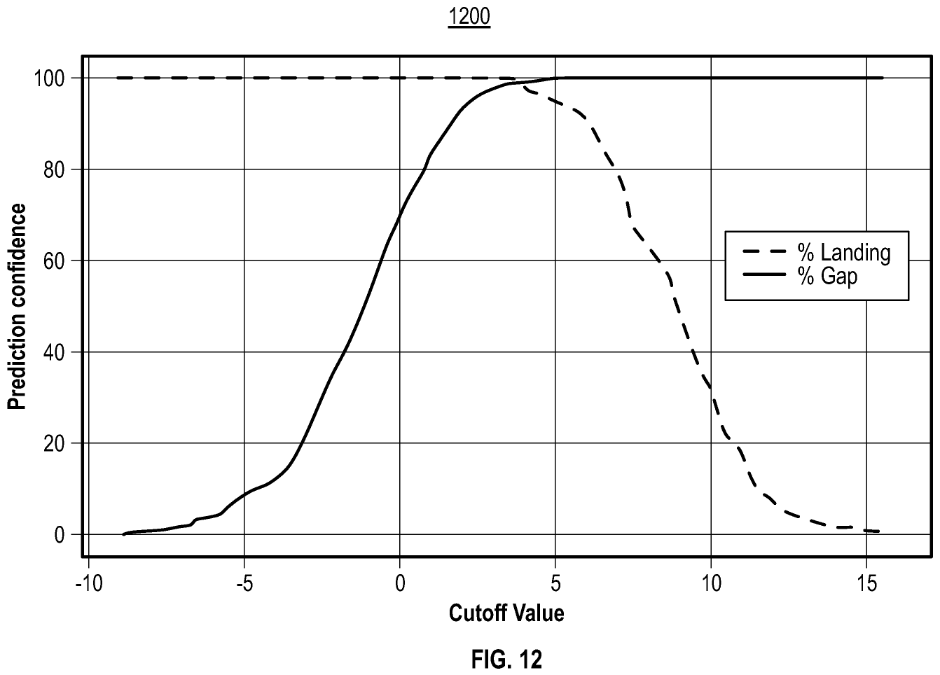

FIG. 12 shows a plot 1200 of probability to properly classify an aligned landing versus a gap landing. From the plot 1200, a method may select s_{T}=3.4 as that value appears to classify over 99 percent of the samples. As an example, for a more nuanced model, an option may be to approximate the score distributions for aligned landings versus gap landings, and rather give probabilities to each class (aligned vs gap) using the found density probability functions and softmax.

The approach of the foregoing trial may be performed for a larger dataset, which may result in even better scores. As an example, one or more of different types of pre-processing of signal vectors x may also be applied. For example, using abs(x) instead of x, a method can increase the precision from 99.11 percent to 99.55 percent.

As an example, a system may include a multi-sensor inference. For example, to increase precision, a system may utilize more than one transducer to improve a ML model. Such an approach may involve particular pre-processing and/or post-processing. As to pre-processing, readings of transducers may be combined and viewed as a single input. For example, consider concatenating the signals according to the following equation:

$$x = [ {x}_{1}^{( 1 )} , … , {x}_{n}^{( 1 )} , {x}_{2}^{( 2 )} , … , {x}_{n}^{( 2 )} , … , {x}_{n}^{( k )} ]$$

where, k is a given number of transducers with signals x⁽ⁱ⁾=[x₁⁽ⁱ⁾, . . . , xₙ⁽ⁱ⁾] from transducer i.

In such an approach, the input signals length can depend on the number of transducers. One or more other prepressing options may include averaging over transducers and recombining the signals in some other way.

In a post-processing approach, a ML model may be trained to optimize prediction given a single transducer signal. For example, network scores of each transducer can be compared for a better approximation than from an individual transducer. In such an example, even though the score from one transducer is unclear, the score from one or more others might clarify a classification (e.g., a result). As an example, given two transducers, consider plotting each landing as a 2D point where the 1st dimension shows the score of the 1st transducer (Nor1), and the 2nd dimension of the 2nd transducer (Nor2).

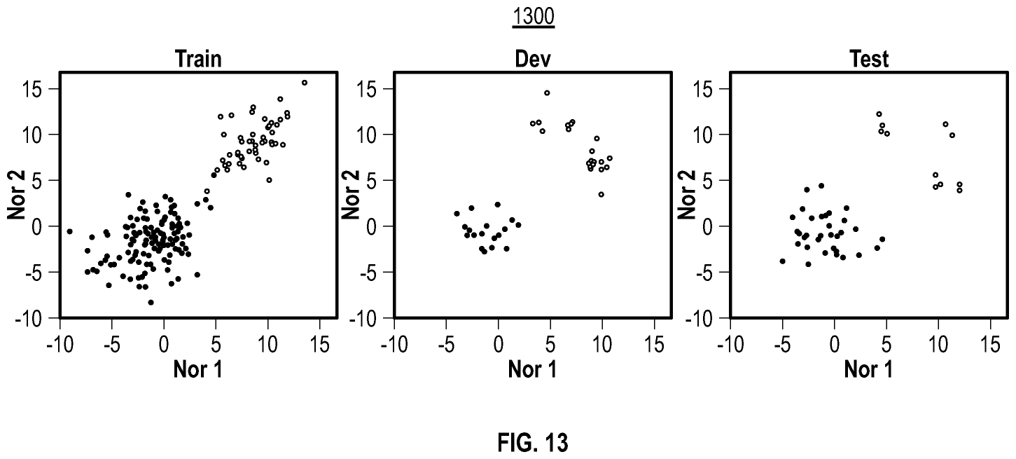

FIG. 13 shows a series of plots 1300 that utilize data from the histograms of the plots 1200 of FIG. 12. In the plots 1300, black dots show unacceptable gap landings and red acceptable alignments. Note that many of the uncertainties from the analysis of a single transducer scores now disappear. In the test data set, an overlap existed between unacceptable gaps and acceptable landings around a score of 5, which disappears as the two transducers do not record such ambiguous scores at the same time.

As explained, one or more types of equipment processes may be assessed and/or controlled. For each of the processes, a suitable ML model may be selected and trained to generate a trained ML model and/or an ensemble of trained ML models. In a field process, data can be acquired, optionally without acquiring data previously for the instance of equipment of that field process.

As an example, a method can include acquiring field data (x, y) and evaluating performance of a ML model trained on laboratory data. In such an example, where the ML model generates acceptable results for one or more of multiple wells (e.g., without exceptions), then that ML model may be suitably implemented. In such an example, the laboratory conditions can be assumed to be similar enough to the field conditions for generalizations to be made.

However, if there is a difference, a method can include retraining the vector θ. Such retraining may be performed by creating variations in a laboratory environment, for example, to make the training data more diverse. Once this is accomplished, a new vector θ can be found on these data, which may be more robust to various environmental factors. The new trained ML model may be implemented in the field where results can be analyzed, for example, to determine whether further data, revisions, etc., are appropriate or not.

In various instances, laboratory data may be insufficient, in part or in whole, to acceptably train an ML model. In such an example, a method can include training a ML model using data from the field where the data may be collected from one or more of multiple wells (e.g., to provide generativity, etc.).

As explained, a ML model can be utilized to assess and/or control a process where components may be brought into proximity, optionally in contact.

In various examples, a ranking network can be utilized to assign individual data points a corresponding scalar value. For example, consider a method that involves handling a binary classification task, a regression task, etc., as a ranking task. By viewing such tasks as involving ranking rather than regression or classification, a problem and solution may be simplified for a ML model, for example, to allow the ML model to focus on order of outputs rather than absolute size of outputs. Such an approach can allow a ML model to use its resources more effectively than in the classical approaches. Further, by focusing on relationships between samples, rather than their absolute values, a method can handle tasks where absolute value labels do not exist but where relationships between data points may be known a prior. As an example, a method may handle time series of samples, where it is known, a priori, that an underlying property is increasing or decreasing (e.g., monotonically, etc.).

As explained, in the oil and gas industry, various types of components can be moved to achieve a desired positional relationship between the components. For example, consider a workflow that aims to properly attach one component to another component where a sensor or sensors may acquire acoustic echoes (e.g., as sensed at an exterior surface, etc.). As an example, for classification, a method may be implemented that can distinguish between aligned attachments and offset attachments. As an example, for regression, a method may be implemented that can estimate size of an offset. As an example, a method may be implemented that can learn when components attach, optionally without use of other labels. For example, consider an approach that can know later samples are more likely to be attached than earlier samples.

As an example, a method may include training one or more ML models using one or more types of learning. For example, consider supervised learning and unsupervised learning as two types of learning.

As an example, ranking network models (e.g., RankNet, etc.) can be robustly applied for assessment and/or control (e.g., without resorting to binary classification or regression). Compared to regression or classification networks, various ranking networks do not demand mapping of data points to particular values, as long as those data points are properly ordered in-between. Under such conditions, capacity normally reserved for mapping can be free for ordering, which may allow one or more ranking network models to perform better than classical classification or regression approaches.

As an example, a ranking approach can be cast as a pairwise relationship between data points approach, which means that “regression” may be performed for tasks that may lack explicit labels. For example, in a time series of observations [o₁, o₂, . . . , oₙ], it may be determined that an underlying quality is increasing or decreasing. In such an example, observation o₁ may represent a machine working without faults where oₙ represents the same machine n time-increments later, for example, when an issue (e.g., failure, etc.) has occurred. For the time series, the “quality” of the machine at a particular time may be unknown where, upon a comparison of (oᵢ, oⱼ), the quality may be higher for whichever observation occurred first.

As explained, a method can involve ranking losses as an alternative to binary classification and regression. Various examples that utilize a ranking approach are applied to equipment scenarios that can arise in the context of field operations in the oil and gas industry. For example, consider scenarios where acoustic data can be acquired to assess and/or control a process that aims to attach one component to another component (e.g., landing a component on a seat of another component, etc.).

In various instances, a method may involve acoustic attachment control that can estimate whether two components are properly attached to each other by analyzing echo signatures from a transducer placed on one of the components.

As an example, consider classification where, once components are attached to each other, a ML model can distinguish between an acceptable alignment and an attachment with a small alignment offset (e.g., a defined unacceptable alignment).

As another example, consider regression where, once components are attached to each other, a ML model can estimate a distance to achieving an acceptable alignment for the components.

As yet another example, consider unsupervised regression where, given time series during which components attach to each other, a ML model can learn to detect when an acceptable connection occurs (e.g., an acceptable alignment, etc.), which may depend on using knowledge that latter observations are more likely to represent an acceptable connection.

The three foregoing examples may utilize a ranking approach where, for example, differences pertain to data or how different data points are ranked relative each other. For comparison, various trials implement regular binary classification or regression, using the same networks.

Results demonstrate that the ranking approach can perform better than the baseline classical approaches. Further, results indicate that the ranking approach can also perform more robustly with respect to initialization and training parameters.

As mentioned, the Rank Net model can be utilized as an example. Such a model can utilize cross-entropy-loss (e.g., rather than mean squared error (MSE) after using a sigmoid function). Cross-entropy loss, or log loss, can measure performance of a classification model whose output is a probability value between 0 and 1. Cross-entropy loss may perform adequately for classification, while MSE may perform adequately for regression.

As to a pairwise approach, a learning-to-rank problem may be approximated by a classification problem. For example, consider learning a binary classifier h(Xu, Xx) that can tell which document is better in a given pair of documents. In such an example, the classifier can take two images as its input where a goal is to minimize a loss function L(h;xᵤ, xᵥ, y_{u,v}).

In various instances, the binary classifier can be implemented with a scoring function f(x). As an example, RankNet adapts a probability model and defines the binary classifier as the estimated probability of a document Xu has higher quality than a document xᵥ: P_{u,v}(f)=CDF(f(xᵤ)−f(xᵥ)), where CDF is a cumulative distribution function (e.g., CDF(x)=(1+exp(−x))⁻¹).

In various oil and gas industry field operations, one or more sensors may acquire a relatively large amount of time series data where “longer” vector may provide for more comparisons. In comparison to an image problem, time series data may utilize a binary classifier where effort is not utilized in getting images into the right order and not utilized for determining absolute differences between images. Where desired, such absolute value determinations may be made, for example, via a mapping that may occur after an assessment, control, etc. Where time series data are utilized, an approach will not demand human vision for labeling, etc.

In various examples, approaches are utilized for two components that are being attached to each other. As explained, a component may be relatively inaccessible because it is inside a bore of another component. In such a scenario, the connection may be in an inaccessible location, making verification of proper attachment problematic to perform.

In an attachment process, it may be helpful to know (i) have the components attached and (ii) if they are attached, have the components attached properly aligned or is there a gap, an offset, a misalignment, etc.

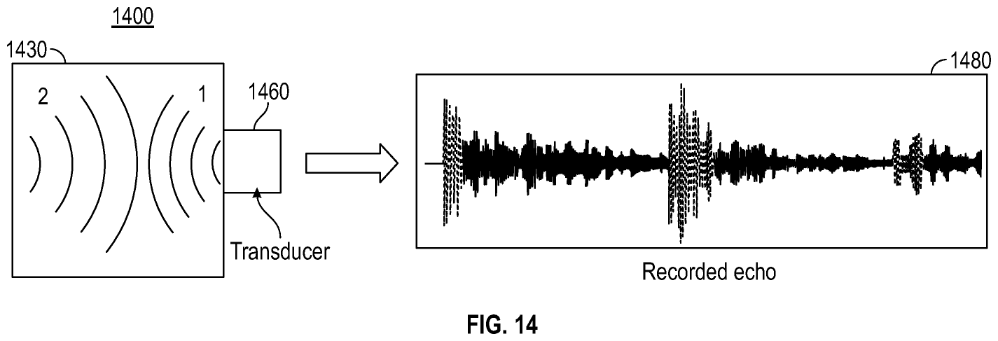

FIG. 14 shows an example of a system 1400 that includes a component 1430 and a transducer 1460 that can emit energy and receive energy (e.g., ultrasonic), for example, as an echo that is a time series of values 1480.

As an example, the time series of values 1480 can be a recorded signal that is 8192 time increments in length. As explained, data may be collected in a laboratory environment where attachment and offsets can be appropriately measured.

As an example, a process can include noting when components move into attachment (dynamic), when components are held still while attached (static), and when components are taken apart (dynamic).

As an example, an offset of 0 can define an acceptable alignment. As an example, a process can provide one static and two dynamic sequences of recorded echoes. Additionally, static sequences may be replaced by a mean signal in order to reduce noise.

For example, consider a process where 542 static signals are measured offsets along with measurement of 1084 dynamic sequences. In such an example, 170 instances had perfect alignments and 372 had various degrees of offset.

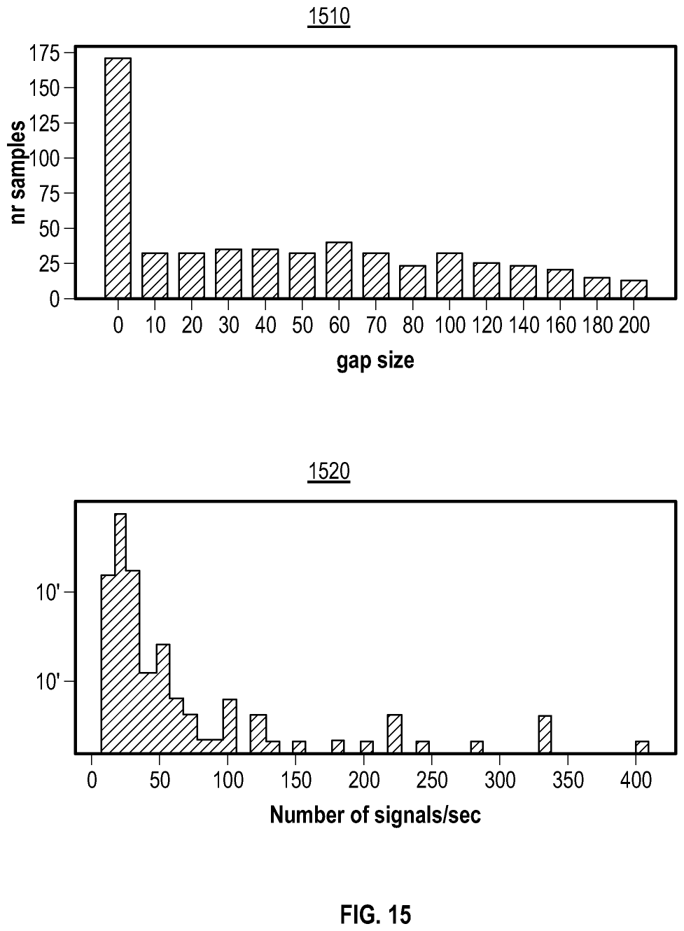

FIG. 15 shows an example plot 1510 of a histogram of samples and gap size and an example plot 1520 of dynamic data that vary in length between 6 and 410 samples, with a mean of 28 samples. In particular, the plot 1520 shows a distribution of sequence lengths in the dynamic data set with 1084 sets, each with a sequence of 6 to 410 signals, with a mean at 28 signals and 30816 in total (note y-axis is in log 10).

Given acquired data, a method can include training one or more ML models to perform one or more of the following tasks: 1) binary classification (e.g., distinguish offset=0 from offset>0); 2) regression (e.g., estimate the actual offset); and 3) unsupervised regression (e.g., predict when equipment comes into contact, etc.).

For the first two tasks, consider using measured offsets as labels together with the corresponding mean signals, from the static part of the data collection. For the third task, consider using dynamic sequences where the equipment is either moved into contact, taken apart, etc. A method can include using knowledge that pieces of equipment are not in contact at one end of a sequence and in contact at another end of the sequence where, for example, there may be an assumed monotonic transition between these such ends.

Depending on available resources, type of implementation (e.g., tool-based microcontroller, etc.), task(s), etc., an appropriate ML model may be selected. For example, consider a site-based controller that may provide for control of a process where components are to be positioned such as in an alignment process. In various instances, a focus may be placed primarily on training a given network (e.g., ranking approach versus regression/classification) with a lesser focus on optimal ML model architecture for a task.

In various instances, multiple ML models may be utilized; though a single ML model may suffice. For example, consider a ML model for a binary classification task that utilized a dot product:

$${f}_{θ} ( x ) = θ \cdot x$$

where x is one recorded echo of an ultrasonic transducer, and θ is the weights of the network.

In such an example, as each sound signal x has a length of 8192 values, so does θ. Note that this dot-product is akin to a one-layered perception without a bias.

For more complicated tasks of regression for offset and contact prediction, consider use of a CNN.

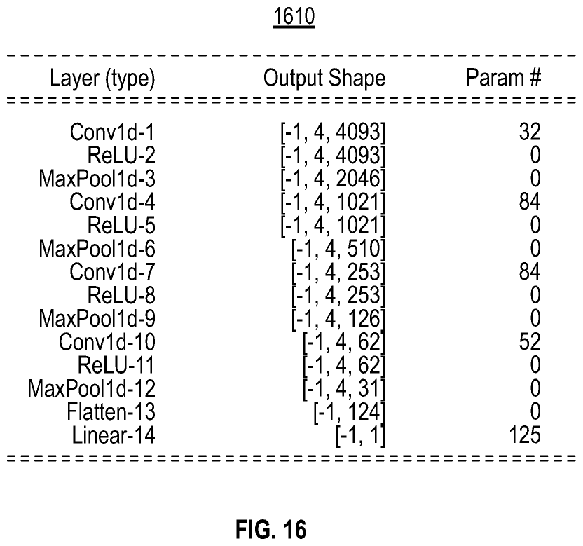

FIG. 16 shows a table 1610 of various architectural characteristics of a CNN, which includes 377 trainable parameters. As shown, the CNN includes layers of various types (e.g., Conv1d, ReLU, MaxPool, Flatten and Linear), output shapes and number of parameters for each layer.

For training, consider a ranking approach (e.g., RankNet, etc.), which may be an alternative to a classical binary classification and regression. A RankNet approach can be defined by a loss that is based on how the outputs relate to each other, pairwise (e.g., rather than a particular neural network architecture). For example, consider two data points (xᵢ, xⱼ) as input where a score network f: X→R is to output a higher score for the higher ranked data point. In such an approach, consider defining xᵢ [symbol] xⱼ to mean that xᵢ is ranked higher than xⱼ, where ideally:

$${x}_{i} ⊳ {x}_{j} ⇒ f ( {x}_{i} ) > f ( {x}_{j} )$$

Such an approach can be described as a binary classification problem, where an estimated probability \tilde{p}ᵢⱼ=P(xᵢ [symbol] xⱼ) can be defined as:

$${\tilde{p}}_{ij} = σ ( f ( {x}_{i} ) - f ( {x}_{j} ) )$$

with σ(z) as the sigmoid function:

$$σ ( z ) = \frac{1}{1 + {e}^{- z}}$$

Thus, \tilde{p}ᵢⱼ approaches 1 as ƒ(xᵢ)>>ƒ(xⱼ), and 0 as f(xᵢ)=f(xⱼ). Using the Cross Entropy Loss function, a pair-loss can be expressed as:

$${l}_{ij} = - {p}_{ij} log {\tilde{p}}_{ij} - ( 1 - {p}_{ij} ) log ( 1 - {\tilde{p}}_{ij} )$$

where pᵢⱼ is the ground truth:

$${p}_{ij} = \{ \begin{matrix}1 , {x}_{i} ⊳ {x}_{j} \\ 0 , {x}_{i} ⊲ {x}_{j}\end{matrix}$$

Consider setting Iᵢⱼ=0 when xᵢ and xⱼ are of the same rank. Then, given a set X={xᵢ}ᵢ₌₁^{N} of data points, a complete loss can be computed:

$$L = {\sum }_{i = 1}^{N} {\sum }_{j = 1}^{i - 1} {l}_{ij}$$

As an example, a method can include computing a pairwise prediction error via computation of the probability that \tilde{p}ᵢⱼ equals pᵢⱼ, after being rounded to 0 or 1.

To accelerate computation of the loss and error during execution, as an example, a method can proceed without computing each score f(xᵢ) more than once, provided that the data set x is small enough to be passed through a network as a single batch. Once the values are computed they may be quickly recombined (see, foregoing equation for L).

Using a loss based on pairwise comparisons changes the train/dev-split of the dataset x somewhat. For example, consider two variations. If there are multiple independent datasets {xₖ}ₖ₌₁^{K} where relationships between points in different sets are not known, a method can assign some sets xₖ to the training set, and others to the dev set; whereas, in another approach, a method can split a single set, which may provide a better estimate on the dev set by also comparing its members to the training set.

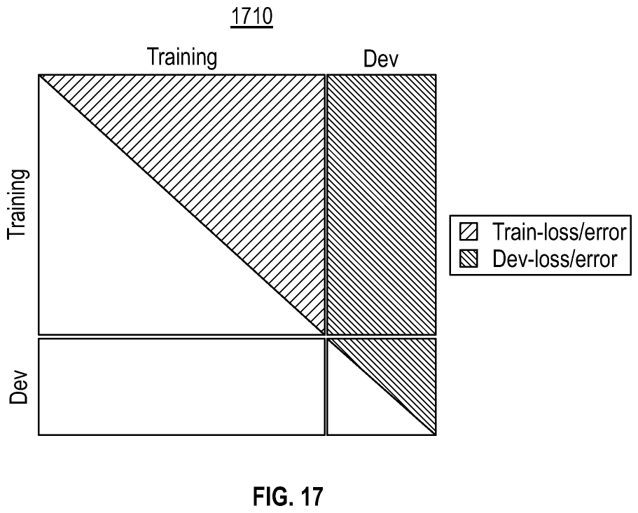

FIG. 17 shows an example plot 1710 for an overview of how rank-loss and error can be computed for a training set and a development set (dev set). Observe that the scores of validation data are compared both to themselves (dev, dev) and the training data (dev, train), while the training loss and error consider solely pairs of training samples (train, train).

As explained, a ranking loss may be utilized for one or more tasks. For example, consider a method that applies a ranking loss to the three tasks described previously. In such an example, training can be made identically between trials, where main differences can pertain to defining xᵢ [symbol] xⱼ, and what data {xᵢ}ᵢ₌₁^{N} to utilize. Such trials can be compared to a classical way of solving each of the corresponding tasks. To evaluate the performance of the trained networks, data can be divided into a training set and a development set. The development data can be selected from different days of data collection than the training data (e.g., to help reduce contamination) where the training set has access to day-specific information in the development set. In such an approach, a train/dev-split resulted in a training set of 372 data collection events, of which 102 had an offset of 0 and a development set of 102 data collection events of which 68 had an offset of 0.

A “data collection event” refers to a process that results in 1 average sound signal for an echo (during the static phase of collection) together with the measured offset, and 2 sequences of sound signals, during which the equipment is either moved into contact or taken apart (during the dynamic phases of data collection).

A method can include predicting whether two pieces of equipment in contact are aligned (e.g., without an offset). Such a method can use the static data set (with the average sound signals) with the pairwise label:

$${x}_{i} ⊳ {x}_{j} = \{ \begin{matrix}1 , i : aligned , j : offset \\ 0 , i : offset , j : aligned\end{matrix}$$

As an example, a ML model can be a dot-product network, as previously described.

Results can be compared with classical binary classification. For example, consider using the same network but adding a sigmoid function to the output to force it into a [0,1] range. A comparison can also include adding a bias b to allow the network to shift its outputs with respect to the sigmoid function. Such an approach provides the network:

$${f}_{θ}^{( bin )} ( x ) = σ ( θ \cdot x + b )$$

As a label yᵢ to each sample xᵢ, set:

$${y}_{j} = \{ \begin{matrix}1 , & {x}_{i} ifaligned \\ 0 , & {x}_{i} ifoffset\end{matrix}$$

As to training, a binary cross-entropy loss can be utilized.

To compare the two methods, it is possible to compare the pairwise error, as a solution to the binary classification problem is also a solution to the ranking problem. To assess how the ranking approach performs on the binary classification problem, consider defining a value s* where the comparison can include classifying outputs larger than this value as aligned, and smaller as offset. For the binary classification network this value is simply 0.5. In the ranking approach, consider defining

$${s}^{*} = \frac{{μ}_{0} + {μ}_{1}}{2} ,$$

where μ₀ is the mean score for data with an offset in the training set, and μ₁ is the mean score for the data without offset (i.e., aligned).

For regression, consider using the same static data set as in the previous experiment, but with the difference that the approach now considers offsets {dᵢ}ᵢ₌₁ⁿ such that:

$${x}_{i} ⊳ {x}_{j} = \{ \begin{matrix}1 , {d}_{i} > {d}_{j} \\ 0 , {d}_{i} < {d}_{j}\end{matrix}$$

Due to the increased complexity of this task, consider using the CNN specified with respect to the table 1610 of FIG. 16.

As to a comparison, for regression, consider using the normalized offsets as labels. In such an approach, given an echo-signal x; corresponding to an offset dᵢ, the label can be expressed as:

$${y}_{i} = \frac{{d}_{i}}{{max}_{j} ( {d}_{j} )}$$

where maxⱼ(dⱼ) is the largest measured offset over the data, in this case maxⱼ(dⱼ)=200; where training can use the mean-squared error loss.

As an example, an evaluation can compare the two approaches by analyzing how they perform both on the ranking problem as well as on the regression problem. Ranking performances may be readily compared as the solution to the regression problem is also a solution to the ranking problem. As explained, performance can be computed using pairwise error. To compare the regression performance, a method can include mapping outputs/scores of the ranking network to reasonable offset estimates, for example, using nearest neighbor regression such that a score sᵢ is mapped to the mean offset \tilde{d}ᵢ of the k samples in the training set with the most similar scores by the network. For sake of comparison, a value of 5 was utilized for k (e.g., k=5).

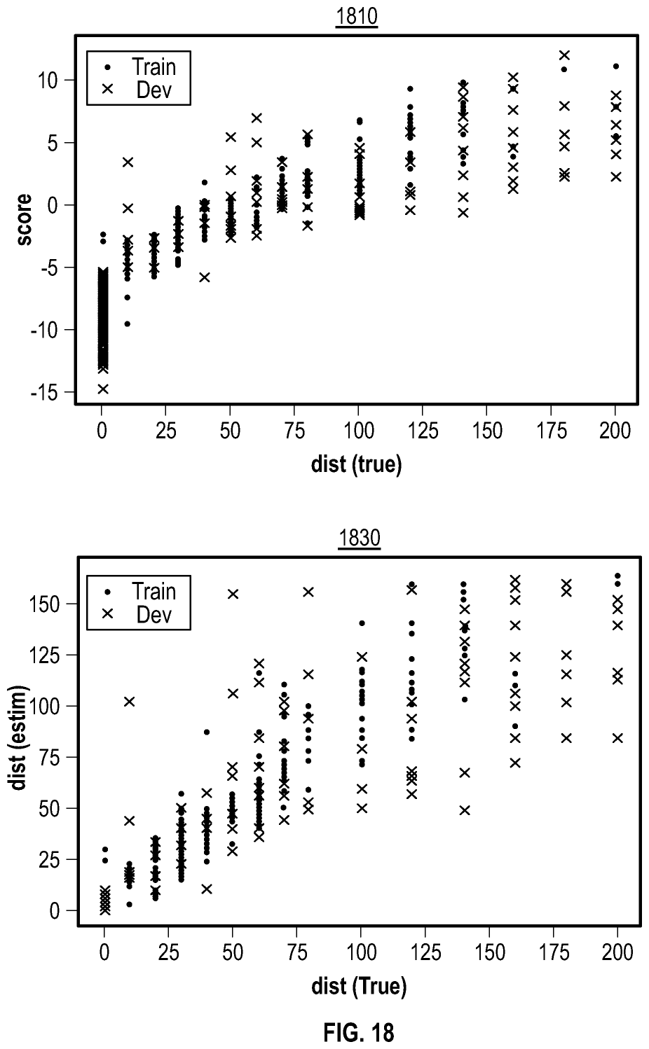

FIG. 18 shows example plots 1810 and 1830 that illustrate the transformation seen where the regression error can then be computed as the average offset |\acute{d}ᵢ−dᵢ|, where dᵢ is the true offset. As mentioned, one way to perform regression from the network scores is via a nearest neighbor regression. As shown in FIG. 18, an estimated offset \tilde{d} of a given score s can be created using the mean offset of the k data points in the training set with the most similar scores.

As to unsupervised regression, consider use of a CNN and dynamic data, with the sequences x^{(k)}={x₀^{(k)}, . . . xₜ^{(k)}, . . . } of recorded echo-signals xₜ^{(k)} during which the equipment is moved into contact, or taken apart. For practical reasons, the order of the sequences can be inverted (inverse order) where the equipment is pulled apart so that each of the sequences starts with the pieces of equipment apart and ends with them in contact. In general, the later in the sequence one looks, the higher the probability that they are in contact. Such an assumption allows for definition of a pairwise label such that:

$${x}_{{t}_{i}}^{( k )} ⊳ {x}_{{t}_{j}}^{( k )} = \{ \begin{matrix}1 , {t}_{i} > {t}_{j} \\ 0 , {t}_{i} < {t}_{j}\end{matrix}$$

Note that the foregoing definition will not allow for comparison of samples from different sequences. To further comparison, consider pre-processing each data set x^{(k)} by subtracting its initial signal x₀^{(k)}, such that rather than observing raw signals one can observe how the signal changes from the initial state where the pieces of equipment are not in contact.

Comparisons can be more difficult where the actual state of the system is unknown between the starting point and the ending point. As an example, a first comparison can involve measuring an amount of change that the signal has undergone since an initial signal where, for a system that is sufficiently simple, the measurement can be good heuristic for determining when the equipment comes into contact, as this leads to a change in recorded echoes. However, there are intermediate states that also change the echo, which become less useful as it is not necessarily known what change corresponds to the pieces of equipment being in contact. As an example, a method can include defining a change detection function as follows:

$${f}^{( chg )} ( {x}_{t} ) = {‖ {x}_{t} - {x}_{0} ‖}_{1}$$

As an example, a second comparison can use regression where one does not know the true state of the system between the start and the end points. In the ranking case a monotonic function could fulfill the pairwise-loss; whereas, for this comparison, a definite decision is to be made for each time step which is guaranteed to differ from the “true” state of the system, causing label noise. To minimize this noise, a method can include approximating a linear transition, such that:

$${y}_{t} = \frac{t}{T}$$

where T is the total length of the sequence of sound signals.

As an evaluation, consider observation of pairwise error, as this is the property that is factually known about the data sets.

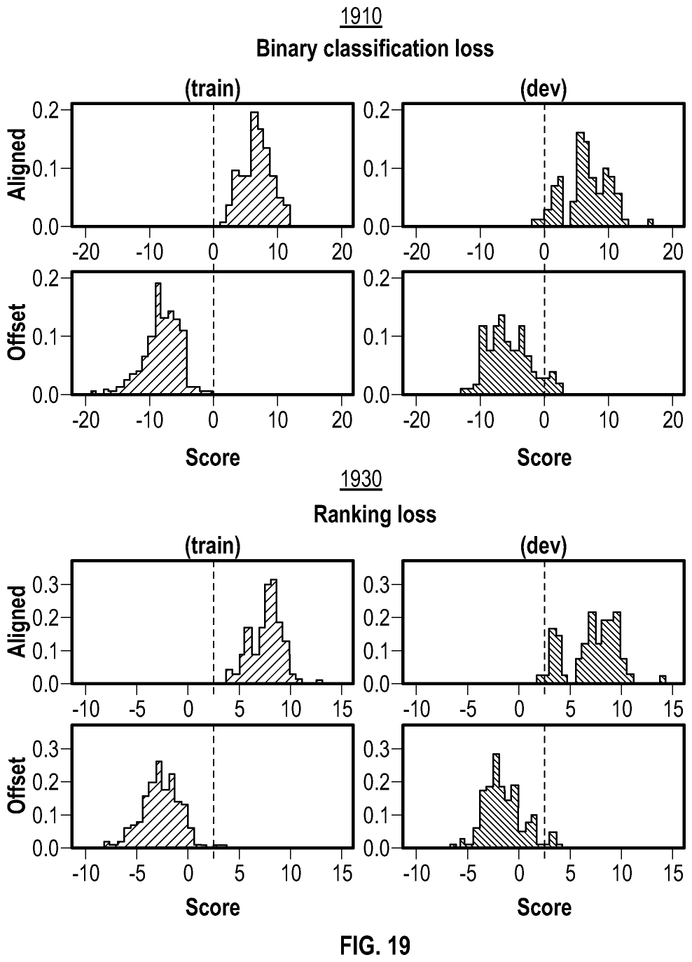

FIG. 19 shows example plots 1310 as to binary classification loss and example plots 1330 as to ranking loss. The plots 1310 and 1330 correspond to the score-distribution of the dot-product network, after being trained using either a ranking loss, or using a binary classification loss. A dotted line shows the threshold for when scores are classified as “aligned” or “offset” in the training set and in the development set. The binary network is illustrated without a sigmoid function such that the threshold can be defined to be 0 (e.g., which could be 0.5 with the sigmoid). The threshold for the ranking approach is set as the mean of the two clusters in the training data.

In the trials, the Adam optimizer was implemented using a step size of 0.001. Results are presented in the table below (Table 1).

TABLE 1
Results

| Trial 1 | Pairwise error | Classification error |
|---|---|---|
| Ranking network | 0.09% | 3.53% |
| Classification | 0.19% | 6.47% |

| Trial 2 | Pairwise error | Regression error |
|---|---|---|
| Ranking network | 7.43% | 20.50 |
| Regression | 8.85% | 24.82 |

| Trial 3 | Pairwise error |
|---|---|
| Ranking network | 6.56% |
| Regression | 8.45% |
| Change detection | 15.78% |

In trial 1, with the dot-product network, the ranking approach performed better in ordering the data points and in classifying the data as aligned or offset. One can also observe that the approach was more robust during training with less risk of over-fitting to the training set. The final distributions of network outputs for aligned versus offset echo-signals can be seen in FIG. 19.

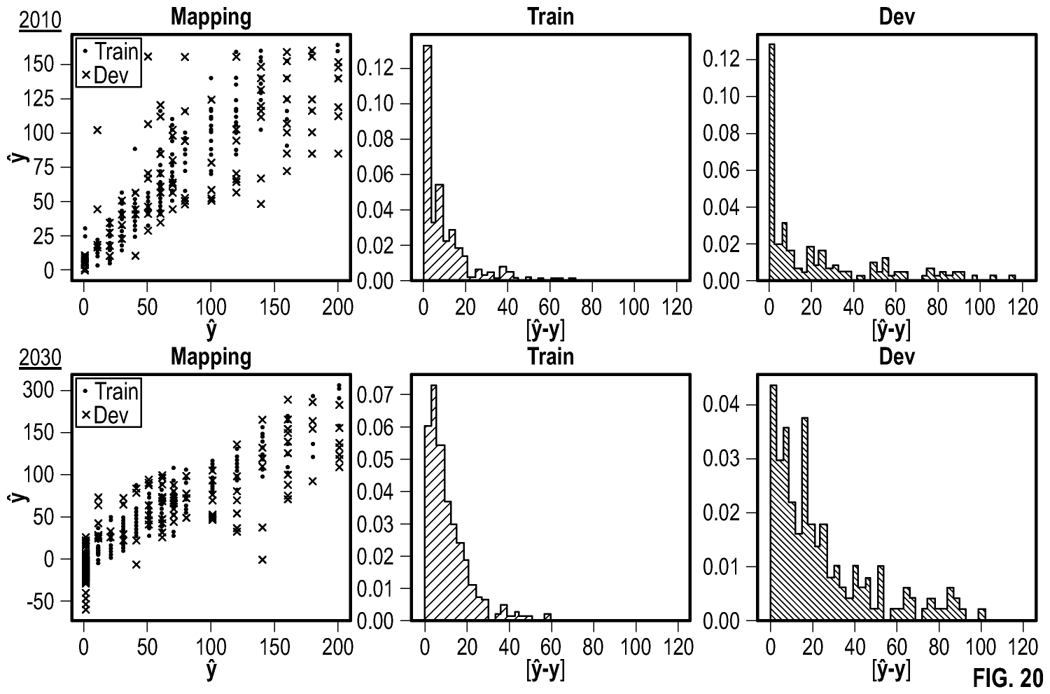

FIG. 20 shows example plots 2010 and 2030 as to trial 2, where the ranking approach produced better results than the traditional approach here as well, with respect to both the ranking problem and the regression problem. The transformation of ranking network scores to offset estimates can be seen in the plots 1810 and 1830 of FIG. 18.

In FIG. 20, the plots 2010 show estimated offsets using the ranking approach, with the distribution of prediction error to the right for the train and dev sets respectively; whereas the plots 2030 show estimated offsets using the regression approach, with the distribution of prediction error to the right for the train and dev sets respectively.

Noted differences between the ranking and regression approaches appear to involve stability. The ranking loss provides improvement in network performance and reaches a local minima at approximately the same iteration of training each time. Training with the regression loss is much less consistent with greater variability when the local minima is reached, after which it quickly over-fits. A reason for this variability is that the network gets stuck at a higher loss-level, with almost no visible improvement over long stretches of time with respect to the regression loss. If one measures the pairwise error however it is visible that the network is improving during this apparently stagnant phase. It is just that this improvement in ordering does not produce any tangible improvement to the regression loss until much later.

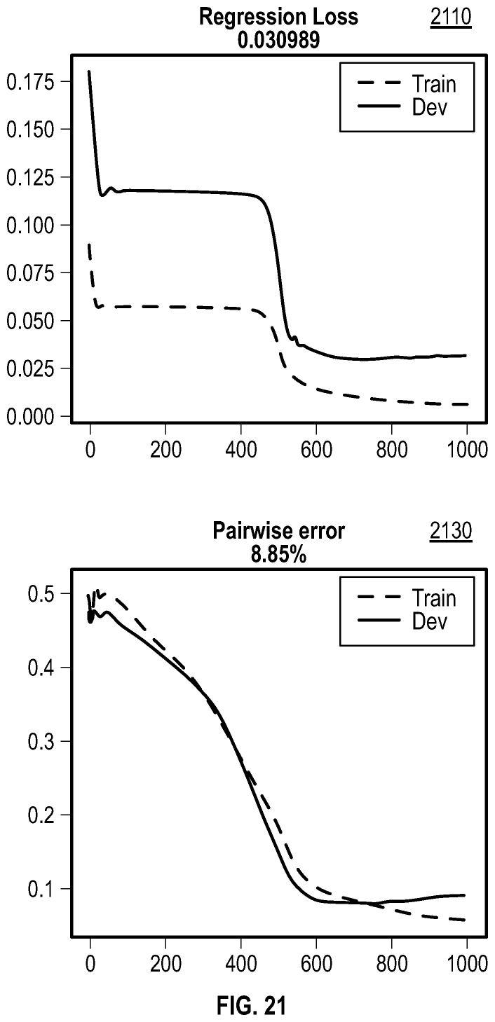

FIG. 21 shows example plots 2110 and 2130 for regression loss and pairwise error, respectively. In particular, the plots 2110 and 2130 show that the regression approach has a tendency to get stuck in a local minima, as can be seen in the plot 2110. However, by measurement of the pairwise error at the same time it is notable that the network is improving during this apparently stagnant phase, although it does not provide much improvement to the regression error.

As to trial 3, which may be considered label-less regression, here also, the ranking approach provides the best results, followed by the regression approach and finally the change detection function.

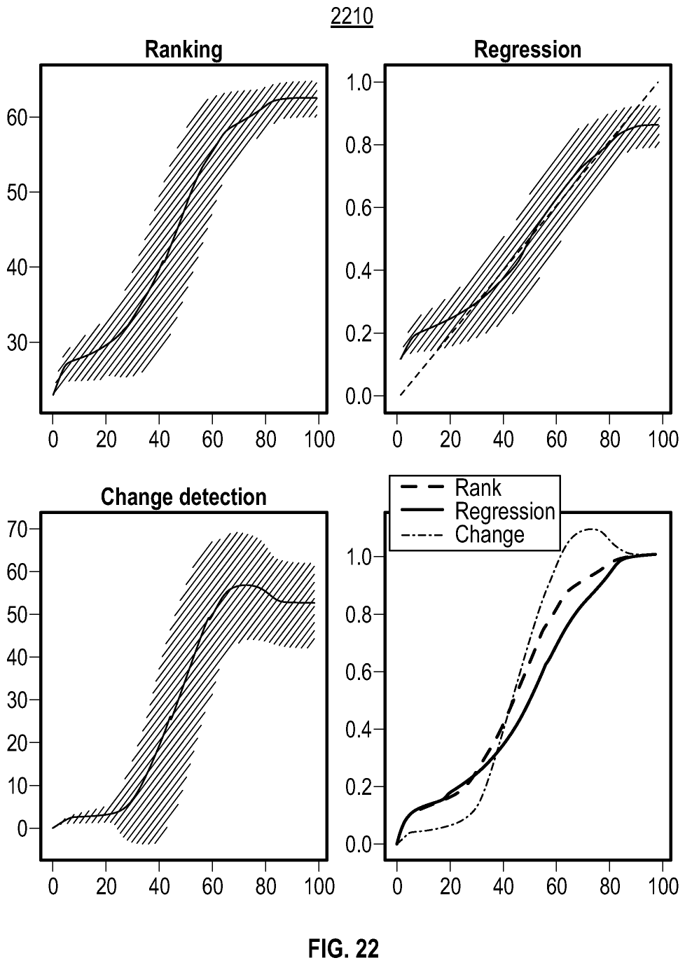

FIG. 22 shows a series of example plots 2210 for average network scores and standard deviations of each network over the development set sequences. Notably, looking at the change detection, some of the intermediate states differ more from the initial state than the final state when the equipment is in contact. These transitional states give a clear motivation of why it could be useful to train a network to sort these intermediate states with respect to the proximity to equipment contact.

In particular, FIG. 22 shows the average scores during landing on the dev-set, with one standard deviation. The x-axis shows completion rate of each sequence, since the number of recorded echo-signals varies greatly between sequences. The dotted line for the regression approach shows the approximated labels for the intermediate states. Note that change detection gives larger values before the final state, while the ranking approach increases monotonically up until the final value.

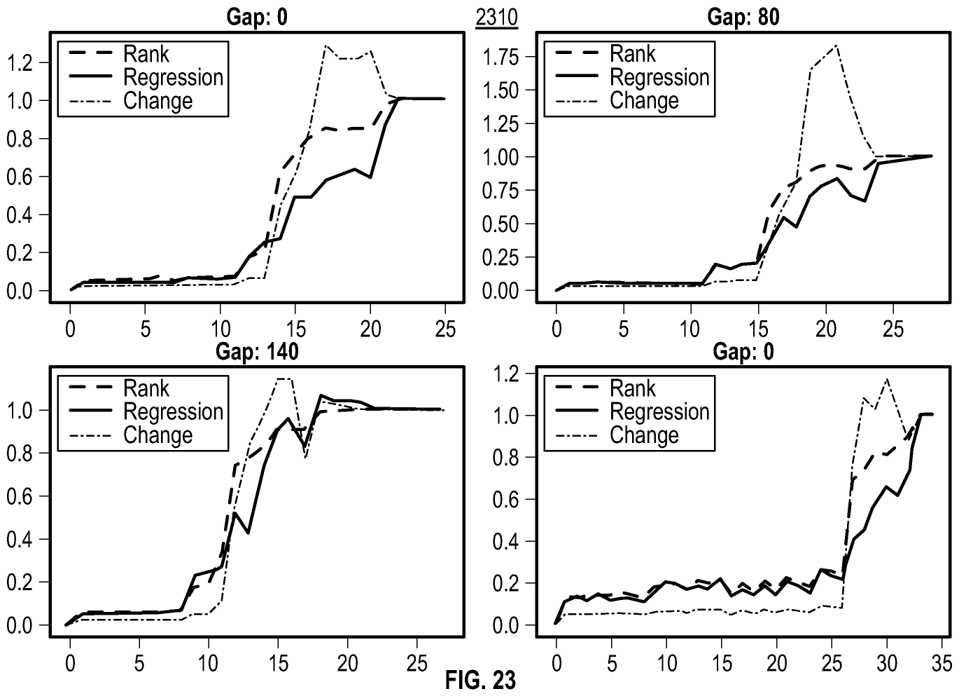

FIG. 23 shows a series of example plots 2310 with some examples of specific sequences and the given network scores. In particular, FIG. 23 shows some examples of score development in sequences in the dev-set. One can observe how the ranking approach leads to a more monotonic increase than the alternatives.

An evaluation assessed whether the given network scores for predicting contact had a relationship to the offset/alignment once the equipment was in contact. The evaluation indicated that no correlations existed for either network.

Through various trials, a ranking based approach provided benefits compared to binary classification and regression when applied to an equipment alignment problem within the oil and gas industry. The ranking approach consistently performed better than the other approaches and did so more robustly with regards to both network architectures and training parameters.

Assume a network that by design can output in the range 0-1, while a task wants to predict some given labels, for example (−0.1,10,100 0) with unknown minimum or maximum values. In such an example, a regression approach cannot solve this problem directly as it will not be able to reach these values as they are outside of its range. Further, even if labels are normalized to the range of the network, the large difference in magnitude means that it cannot really separate values with smaller magnitude, as error with respect to the largest labels will dominate the loss. Such an approach will furthermore break down the moment new data arrives outside of the previously assumed range of the labels.

In comparison, a ranking approach data can be sorted within an available range of network (e.g., ML model), where the actual separation of scores can depend more on how easy it is for the network to determine what samples are better or worse, than on how much better or worse a sample might be compared to another. From the perspective of such a network, it is equally bad to mix up 10 and 1000, as −0.1 and 10. Once the ranking network has sorted the data in its available span 0-1 it can be remapped to the actual range of the data (see, e.g., FIG. 18).

As explained, classical approaches are not suited to trial 3 due to label noise. In this case the given labels are approximate, as one may try to enforce a linear transition between start and finish, which may not represent reality. A lack of knowledge as to intermediate states does not have an effect on the ranking approach as an assumption is that latter echoes are more likely to correspond to the equipment being in contact (e.g., or whatever the latter state may be for a process). Such an assumption holds for a monotonic function between two end points of a sequence; noting that a linear transition assumption is a special case of a monotonic function. In such an approach, ranking labels are truer than the regression labels (with equality if the true transition is a linear transition) and given cleaner labels it is also reasonable to expect better results.

The ranking approach may have an advantage of being readily applied to a range of different problems (e.g., tasks), as long as data samples can be pairwise ordered. For example, in various instances, as explained, a method may be implemented without normalizing data, without adjusting a network to a given output range, etc.

As explained, equipment alignment monitoring and control, using ultrasonic measurements, can be performed using a ranking-based approach. As explained, a ranking approach can work for unlabeled data sets, for example, to assign to different intermediate states appropriate values with respect to how close they are to process completion (e.g., proximity of equipment contact). As an example, a sequence may be assessed as to a monotonic change in underlying properties. In such an example, such a method could be implemented for surveillance of equipment or machinery that tends to break down over time. For example, a ranking network could be used to detect failure trends early on and enforce a preventive maintenance.

In completely different fields, such as medical prognosis, a sequence of images during which a disease develops could, for example, be used to train a ranking network to detect early warning signs even before these are visible to the naked eye. Such an approach may be applied for signs of recovery, using data sequences during which a patient recovers. Yet another use can be in the field of reinforcement learning, for example, as a potential approach to an assignment problem (e.g., credit assignment, etc.).

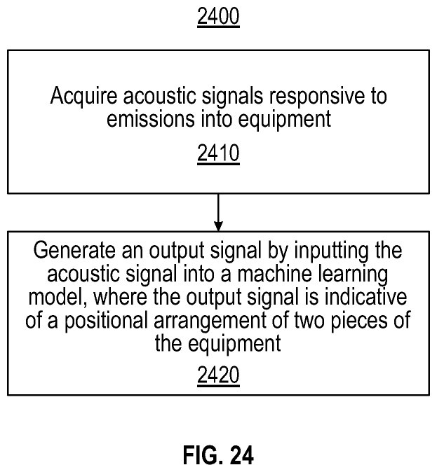

FIG. 24 shows an example of a method 2400 that includes an acquisition block 2410 for acquiring acoustic signals responsive to emissions into equipment; and a generation block 2420 for generating an output signal by inputting the acoustic signal into a machine learning model, where the output signal is indicative of a positional arrangement of two pieces of the equipment. In such an example, the method 2400 may include a control block that issues a control signal that can control a process that includes moving at least one of the two pieces of equipment.

As an example, a unit can include an emitter, a detector, and a microcontroller. In such an example, the microcontroller can perform a method such as the method 2400 of FIG. 24. Such a unit may include an indicator such as an LED, an LED array, an LCD, etc. In such an example, the LED may illuminate to indicate a state of equipment and/or an LED array may illuminate to indicate a state and/or an LCD may render state information.

As an example, a method can include acquiring acoustic signals responsive to emissions into equipment; and generating an output signal by inputting the acoustic signal into a machine learning model, where the output signal is indicative of a positional arrangement of two pieces of the equipment. In such an example, generating can utilize a pairwise comparison of data points of the acoustic signals.

As an example, acoustic signals can be represented vectors where a machine learning model utilizes a vector dot product to compute a score. As an example, a machine learning model (ML model) can be or include a neural network model. For example, consider a convolution neural network (CNN).

As an example, a method can include generating that includes minimizing a loss represented by a loss function. For example, consider a loss function that includes a sigmoid function. In such an example, the sigmoid function can define two states. For example, one of the two states can correspond to two pieces of equipment being in contact with each other and, for example, one of the two states can correspond to the two pieces of equipment not being in contact with each other. As an example, a loss function can include a cross-entropy loss function.

As an example, a machine learning model can be or include a ranking model (e.g., to rank something “better” or “worse” or “more complete” or “less complete”, etc., than something else).

As an example, a positional arrangement of two pieces of equipment can correspond to an initial state or to an end state of a process that moves at least one of the two pieces.

As an example, a position arrangement of two pieces of equipment can correspond to a state that is between an initial state and a desired end state of the two pieces of the equipment.

As an example, a method can include training a machine learning model using labels and/or training a machine learning model without using labels.

As an example, equipment can include well equipment. For example, consider well equipment that includes wellhead assembly equipment.

As an example, a system can include a processor; memory accessible to the processor; processor executable instructions stored in the memory, executable by the processor to instruct the system to: acquire acoustic signals responsive to emissions into equipment; and generate an output signal by inputting the acoustic signal into a machine learning model, where the output signal is indicative of a positional arrangement of two pieces of the equipment.

As an example, one or more computer-readable storage media can include processor executable instructions, executable to instruct a computing system to: acquire acoustic signals responsive to emissions into equipment; and generate an output signal by inputting the acoustic signal into a machine learning model, where the output signal is indicative of a positional arrangement of two pieces of the equipment.

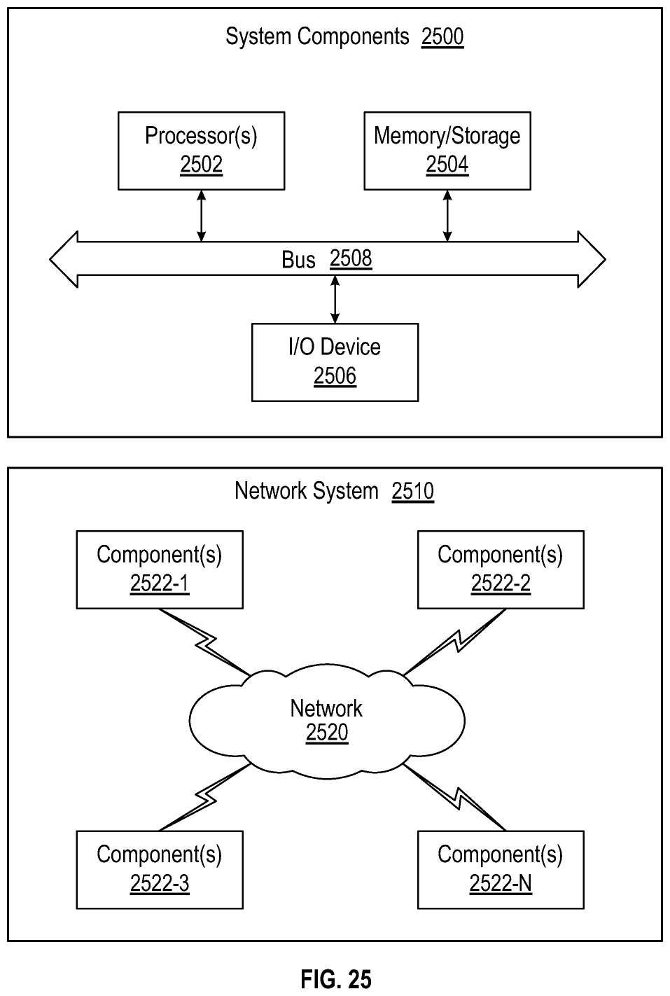

FIG. 25 shows components of an example of a computing system 2500 and an example of a networked system 2510 with a network 2520. The system 2500 includes one or more processors 2502, memory and/or storage components 2504, one or more input and/or output devices 2506 and a bus 2508. In an example embodiment, instructions may be stored in one or more computer-readable media (e.g., memory/storage components 2504). Such instructions may be read by one or more processors (e.g., the processor(s) 2502) via a communication bus (e.g., the bus 2508), which may be wired or wireless. The one or more processors may execute such instructions to implement (wholly or in part) one or more attributes (e.g., as part of a method). A user may view output from and interact with a process via an I/O device (e.g., the device 2506). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2510. The network system 2510 includes components 2522-1, 2522-2, 2522-3, . . . 2522-N. For example, the components 2522-1 may include the processor(s) 2502 while the component(s) 2522-3 may include memory accessible by the processor(s) 2502. Further, the component(s) 2522-2 may include an I/O device for display and optionally interaction with a method. A network 2520 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
acquiring acoustic signals responsive to emissions into equipment; and
generating an output signal by inputting the acoustic signal into a machine learning model, wherein the output signal is indicative of a positional arrangement of two pieces of the equipment.

2. The method of claim 1, wherein the generating utilizes a pairwise comparison of data points of the acoustic signals.

3. The method of claim 1, wherein the acoustic signals are represented vectors and wherein the machine learning model utilizes a vector dot product to compute a score.

4. The method of claim 1, wherein the machine learning model comprises a neural network model.

5. The method of claim 3, wherein the neural network model comprises a convolution neural network (CNN).

6. The method of claim 1, wherein the generating comprises minimizing a loss represented by a loss function.

7. The method of claim 6, wherein the loss function comprises a sigmoid function.

8. The method of claim 7, wherein the sigmoid function defines two states.

9. The method of claim 8, wherein one of the two states corresponds to the two pieces of equipment being in contact with each other.

10. The method of claim 8, wherein one of the two states corresponds to the two pieces of equipment not being in contact with each other.

11. The method of claim 6, wherein the loss function comprises a cross-entropy loss function.

12. The method of claim 1, wherein the machine learning model comprises a ranking model.

13. The method of claim 1, wherein the positional arrangement of two pieces of the equipment corresponds to an initial state or to an end state of a process that moves at least one of the two pieces.

14. The method of claim 1, wherein the position arrangement of the two pieces of the equipment corresponds to a state that is between an initial state and a desired end state of the two pieces of the equipment.

15. The method of claim 1, comprising training the machine learning model using labels.

16. The method of claim 1, comprising training the machine learning model without using labels.

17. The method of claim 1, wherein the equipment comprises well equipment.

18. The method of claim 17, wherein the well equipment comprises wellhead assembly equipment.

19. A system comprising:
a processor;
memory accessible to the processor;
processor executable instructions stored in the memory, executable by the processor to instruct the system to:
acquire acoustic signals responsive to emissions into equipment; and
generate an output signal by inputting the acoustic signal into a machine learning model, wherein the output signal is indicative of a positional arrangement of two pieces of the equipment.

20. One or more computer-readable storage media comprising processor executable instructions, executable to instruct a computing system to:
acquire acoustic signals responsive to emissions into equipment; and
generate an output signal by inputting the acoustic signal into a machine learning model, wherein the output signal is indicative of a positional arrangement of two pieces of the equipment.
